(19) United States
(12) Patent Application Publication
(10) Pub. No.: US 2022/0172187 A1
(43) Pub. Date: Jun. 2, 2022

(54) SYSTEM RELATED TO A SERVICE PROVIDED BY A VOICE CONTROL DEVICE

(71) Applicants: NAVER CORPORATION, Gyeonggi-do (KR); LINE Corporation, Tokyo (JP)

(72) Inventors: Yuya KANEHANA, Tokyo (JP); Sho TACHIBANA, Tokyo (JP); Kento FUJIHIRA, Tokyo (JP)

(73) Assignees: NAVER CORPORATION, Gyeonggi-do (KR); LINE Corporation, Tokyo (JP)

(21) Appl. No.: 17/675,265

(22) Filed: Feb. 18, 2022

Related U.S. Application Data
(63) Continuation of application No. PCT/JP2020/031458, filed on Aug. 20, 2020.

(30) Foreign Application Priority Data
Aug. 20, 2019 (JP) 2019-150375

(51) Int. Cl. G06Q 20/10; G10L 15/22; G06Q 20/32

(52) U.S. Cl. CPC G06Q 20/102; G06Q 20/322; G10L 15/22

(57) ABSTRACT

A system including a memory configured to store an account and a voice control device in association with each other and at least one processor configured to analyze voice data generated based on an utterance accepted by the voice control device, transmit an analysis result to an external server, specify the account that is associated with the voice control device, receive, from the external server, a settlement request for a usage fee of a service, which is provided by the voice control device, and transmit information for settling the usage fee through an operation performed on a terminal that corresponds to the specified account upon receiving the settlement request may be provided.

### CROSS-REFERENCE TO RELATED APPLICATIONS

This application is a continuation of PCT International Application No. PCT/JP2020/031458 which has an international filing date of Aug. 20, 2020, and which claims priority to Japanese Patent Application Number JP2019-150375 filed Aug. 20, 2019, the entire contents of both of which are incorporated herein by reference.

### BACKGROUND

### Technical Field

The present disclosure relates to a system related to a service provided by a voice control device.

### Description Related Art

Recently, services provided by voice control devices such as smart speakers have become increasingly prevalent.

### SUMMARY

Conventionally, consideration has not been given to the payment method that is employed when a user uses a paid service provided by a voice control device.

The present inventive concepts have been implemented to resolve such a problem, and one aspect of the present inventive concepts is to propose a new method for easily settling a usage fee for a service provided by a voice control device. According to an example embodiment, a system may include a memory configured to store an account and a voice control device in association with each other, and at least one processor configured to analyze voice data generated based on an utterance accepted by the voice control device, transmit an analysis result to an external server, specify the account that is associated with the voice control device, receive, from the external server, a settlement request for a usage fee of a service, which is provided by the voice control device, and transmit information for settling the usage fee through an operation performed on a terminal that corresponds to the specified account upon receiving the settlement request.

### BRIEF DESCRIPTION OF DRAWINGS

FIG. 1 is a diagram showing a configuration of a communication system according to an example embodiment.

FIG. 2-1 is a diagram showing a configuration of a smart speaker management server according to an example embodiment.

FIG. 2-2 is a diagram showing a configuration of a skill provision server according to an example embodiment.

FIG. 2-3 is a diagram showing a configuration of a smart speaker according to an example embodiment.

FIG. 3-1 is a diagram showing functions realized by a controller of a terminal according to an example embodiment.

FIG. 3-2 is a diagram showing information stored in a storage device of the terminal according to an example embodiment.

FIG. 3-3 shows functions realized by a controller of a payment management server according to an example embodiment.

FIG. 3-4 is a diagram showing information stored in a storage device of the payment management server according to an example embodiment.

FIG. 3-5 shows payment application user registration data according to an example embodiment.

FIG. 3-6 shows a skill provider registration database according to an example embodiment.

FIG. 3-7 shows functions realized by a controller of a smart speaker management server according to an example embodiment.

FIG. 3-8 is a diagram showing information stored in a storage device of the smart speaker management server according to an example embodiment.

FIG. 3-9 is a diagram showing smart speaker registration data according to an example embodiment.

FIG. 3-10 shows skill registration data according to an example embodiment.

FIG. 3-11 shows functions realized by a controller of the skill provision server according to an example embodiment.

FIG. 3-12 is a diagram showing information stored in a storage device of the skill provision server according to an example embodiment.

FIG. 3-13 shows skill provision basic information data according to an example embodiment.

FIG. 4-1 is a diagram showing a screen displayed on a display of the terminal according to an example embodiment.

FIG. 4-2 is a diagram showing a screen displayed on the display of the terminal according to an example embodiment.

FIG. 4-3 is a diagram a screen displayed on the display of the terminal according to an example embodiment.

FIG. 4-4 is a diagram showing a screen displayed on the display of the terminal according to an example embodiment.

FIG. 4-5 is a diagram showing usage of a smart speaker according to an example embodiment.

FIG. 4-6 is a diagram showing a screen displayed on the display of the terminal according to an example embodiment.

FIG. 4-7 is a diagram showing a screen displayed on the display of the terminal according to an example embodiment.

FIG. 4-8 is a diagram showing a screen displayed on the display of the terminal according to an example embodiment.

FIG. 4-9 is a diagram showing usage of a smart speaker according to an example embodiment.

FIG. 4-10 is a diagram showing a screen displayed on the display of the terminal according to an example embodiment.

FIG. 4-11 is a diagram showing a screen displayed on the display of the terminal according to an example embodiment.

FIG. 5-1 is a flowchart showing a portion of a flow of processing executed by devices according to an example embodiment.

FIG. 5-2 is a flowchart showing a portion of the flow of processing executed by devices according to an example embodiment.

FIG. 5-3 is a flowchart showing a portion of the flow of processing executed by devices according to an example embodiment.

FIG. 5-4 is a flowchart showing a portion of the flow of processing executed by devices according to an example embodiment.

### DETAILED DESCRIPTION

Compliance with Legal Requirements

It should be noted that the disclosure provided herein is premised on compliance with legal requirements such as secrecy of communications in any country in which the present disclosure is to be implemented.

Some example embodiments for carrying out a system according to the present disclosure will be described below with reference to the drawings.

System Configuration

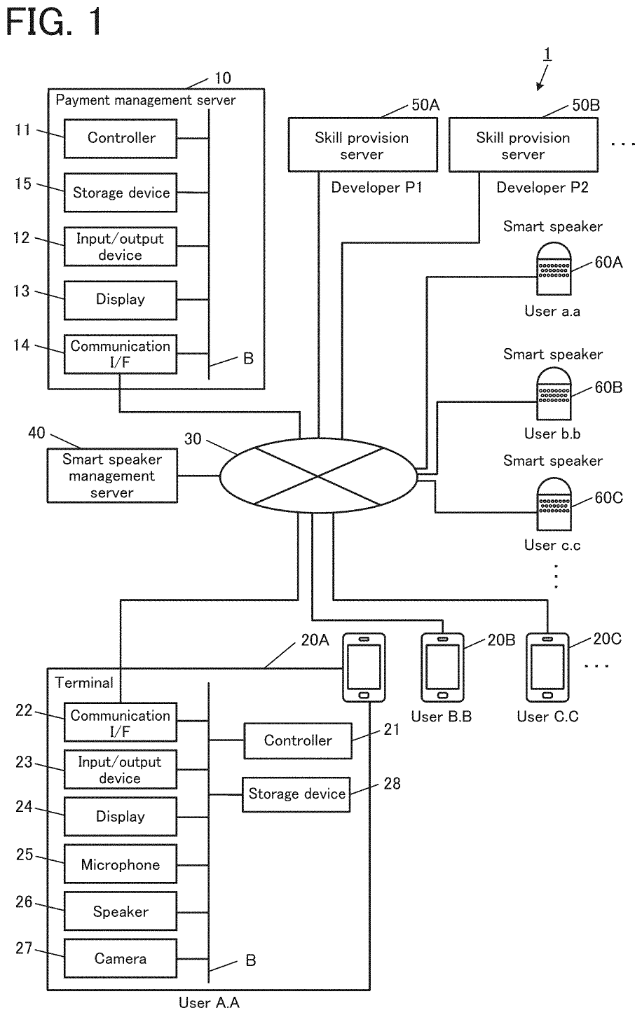

FIG. 1 is a diagram showing a configuration of a communication system 1, according to an example embodiment of the present disclosure.

As shown in FIG. 1, in the communication system 1, a payment management server 10, terminals 20 (a terminal 20A, a terminal 20B, a terminal 20C, . . . ), a smart speaker management server 40, skill provision servers 50 (a skill provision server 50A, a skill provision server 50B, . . . ), and smart speakers 60 (a smart speaker 60A, a smart speaker 60B, a smart speaker 60C, . . . ) are connected via a network 30.

For example, without limitation, the payment management server 10 provides a payment-related service to the terminals 20 in the possession of users and to the skill provision servers 50 via the network 30.

Note that there is no limitation on the number of terminals 20 connected to the network 30 and the number of skill provision servers 50.

The smart speaker management server 40 provides the terminals 20 in the possession of users, the smart speakers 60 in the possession of users, and the skill provision servers 50 with functions related to smart speaker control and management via the network 30.

For example, without limitation, the smart speaker management server 40 receives a voice signal (acoustic signal) transmitted from a smart speaker 60 and converts the voice signal into an intent. Then, the intent is transmitted to a skill provision server 50 in accordance with the content of the intent. When an intent processing result transmitted by the skill provision server 50 is received, the intent processing result is converted into a voice signal (e.g., acoustic signal) and transmitted to the smart speaker 60.

Note that there is no limitation on the number of smart speakers 60 that are connected to the network 30.

Here, for example, without limitation, the intent is an operation instruction request for the smart speaker management server 40 that is vocally given by the user of the smart speaker 60.

Note that the intent may include a word that corresponds to an argument of the operation instruction request, which is called as a slot.

As one specific example, the utterance “set a timer for 3 minutes” is an example of an utterance sentence in an intent representing the operation instruction request “timer setting,” and may include a slot related to the timer operation time, namely “3 minutes.”

The skill provision servers 50 each have a function of executing processing by a skill (application) for an intent received from the smart speaker management server 40 via the network 30, and transmitting a processing result to the smart speaker management server 40.

Note that there is no limitation on the number of smart speaker management servers 40 that are connected to the network 30.

The network 30 plays the role of connecting one or more terminals 20, one or more payment management servers 10, one or more smart speaker management servers 40, one or more skill provision servers 50, and one or more smart speakers 60. For example, the network 30 serves as a communication network that provides connection paths to enable the various types of devices described above to transmit and receive data after the devices are connected to each other.

One or more portions of the network 30 may optionally be a wired network or a wireless network. Non-limiting examples of the network 30 include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the public switched phone network (PSTN), a mobile phone network, integrated service digital networks (ISDNs), a radio LAN, long term evolution (LTE), code division multiple access (CDMA), Bluetooth (registered trademark), satellite communication, and a combination of two or more of these networks. The network 30 may be constituted by a single network 30 or a plurality of networks 30.

The terminals 20 (terminal 20A, terminal 20B, terminal 20C, . . . , which are non-limiting examples of a terminal or an information processing device) may each be any type of terminal as long as it is an information processing terminal that is capable of implementing the functions described in the disclosed example embodiments. Non-limiting examples of the terminals 20 include a smartphone, a mobile phone (a feature phone), a computer (non-limiting examples of which include a desktop, a laptop, and a tablet), a media computer platform (non-limiting examples of which include cable and satellite set-top boxes and a digital video recorder), a handheld computer device (non-limiting examples of which include a personal digital assistant (PDA) and an electronic mail client), a wearable terminal (an eyeglasses-type device, a watch-type device, etc.), and other types of computers and communication platforms. The terminals 20 may also be referred to as “information processing terminals”.

The configurations of the terminals 20A, 20B, and 20C are basically the same as each other, and therefore the following describes a terminal 20. The user information is information regarding a user associated with an account that is used by the user in the desired (or alternatively, predetermined) service. Non-limiting examples of the user information include information that is input by the user or is assigned by the desired (or alternatively, predetermined) service, and is associated with the user, such as the user's name, an icon image of the user, the user's age, the user's gender, the user's address, the user's hobbies/preferences, and a user identifier, and the user information may optionally be any one of or a combination of two or more of these pieces of information.

The smart speaker 60 (smart speaker 60A, smart speaker 60B, . . . , which are non-limiting examples of a voice control device, an acoustic control device, an interaction device, and an information processing device) may be any electronic device as long as it is an information processing device that is capable of implementing the functions described in the disclosed example embodiments. Note that the smart speaker may have a display screen (display).

If the smart speaker is considered to be a single unit, it can be said to be an audio input device, an audio output device, or an audio input/output device. The smart speaker can also be said to be a communication device that recognizes a keyword (wake word) and makes an audio streaming connection to the smart speaker management server 40.

Non-limiting examples of the smart speaker 60 include a smart speaker or an artificial intelligence speaker (AI speaker), a smart home appliance, a smartphone, a computer (non-limiting examples including a desktop, a laptop, and a tablet), a media computer platform (non-limiting examples including a cable box, a satellite set-top box, and a digital video recorder), a handheld computer device (non-limiting examples including a personal digital assistant and an e-mail client), a wearable terminal (non-limiting examples including a glasses-type device and a watch-type device), and other types of computers and communication platforms. If the smart speaker 60 is configured to be capable of voice interaction with the user, the smart speaker 60 can also be referred to as an interaction device.

Note that the smart speaker 60 may or may not have some or all of the functions of the smart speaker management server 40 and/or the skill provision server 50.

The payment management server 10 (a non-limiting example of a server, an information processing device, or an information management device) functions to provide a desired (or alternatively, predetermined) service to the terminal 20. The payment management server 10 may be any information processing device that is capable of implementing the functions described in the disclosed example embodiments. Non-limiting examples of the payment management server 10 include a server device, a computer (non-limiting examples of which include a desktop, a laptop, and a tablet), a media computer platform (non-limiting examples of which include cable and satellite set-top boxes and a digital video recorder), a handheld computer device (non-limiting examples of which include a PDA and an e-mail client), and other types of computers and communication platforms. The payment management server 10 may also be referred to as an “information processing device”. If there is no need to distinguish between the payment management server 10 and the terminal 20, the payment management server 10 and the terminal 20 may each optionally be referred to as an “information processing device”.

The smart speaker management server 40 (non-limiting examples including a server, an information processing device, and an information management device) may be any device as long as it is an information processing device that is capable of implementing the functions described in the disclosed example embodiments. Non-limiting examples of the smart speaker management server 40 include a server device, a computer (non-limiting examples including a desktop, a laptop, and a tablet), a media computer platform (non-limiting examples including a cable box, a satellite set-top box, and a digital video recorder), a handheld computer device (non-limiting examples including a personal digital assistant and an e-mail client), and other types of computers and communication platforms. The smart speaker management server 40 may be called an information processing device.

The above description similarly applies to the skill provision server 50.

Note that the smart speaker management server 40 may or may not have some or all of the functions of the skill provision server 50. Further, the system of the present disclosure may have a configuration in which these servers are constituted by the same server rather than being separate.

Further, the payment management server 10 may or may not have some or all of the functions of the skill provision server 50. In some example embodiments, the system of the present disclosure may have a configuration in which these servers are constituted by the same server rather than being separate.

Hardware Configurations of Devices

Hardware configurations of the devices included in the communication system 1 will be described below.

(1) Hardware Configuration of Terminal

FIG. 1 shows an example of the hardware configuration of the terminal 20.

The terminal 20 includes a controller 21 (e.g., central processing unit: CPU), a storage device 28, a communication I/F (interface) 22, an input/output device 23, a display 24, a microphone 25, a speaker 26, and a camera 27. The hardware constituent elements of the terminal 20 are connected to each other via a bus B, for example, without limitation. Note that the hardware configuration of the terminal 20 does not necessarily need to include all of such constituent elements. The terminal 20 may optionally be configured such that one or more constituent elements such as the microphone 25 and the camera 27 are removable, for example, without limitation.

The communication I/F 22 transmits and receives various types of data via the network 30. The communication may be carried out in a wired or wireless manner, and may be based on any communication protocol that enables mutual communication to be carried out. The communication I/F 22 communicates with various types of devices such as the server 10 via the network 30. The communication I/F 22 transmits various types of data to the various types of devices such as the server 10 in accordance with instructions from the controller 21. Further, the communication I/F 22 receives various types of data transmitted from the various types of devices such as the server 10 and conveys the data to the controller 21. The communication I/F 22 may also be simply referred to as a “communication device”. The communication I/F 22 may also be referred to as a “communication circuit” in cases where the communication I/F is constituted by a physically structured circuit.

The input/output device 23 includes a device that inputs various operations made to the terminal 20 and a device that outputs a result of processing performed by the terminal 20. The input/output device 23 may optionally be constituted by an input device and an output device that are configured as a single device or are separate from each other.

The input device is implemented by any one of or a combination of two or more of all types of devices capable of accepting input from a user and conveying information regarding the input to the controller 21. Non-limiting examples of the input device include a push button, a touch panel, a touch display, hardware keys of a keyboard or the like, a pointing device such as a mouse, a camera (e.g., a device configured to receive an input of operations via moving images), and a microphone (e.g., a device configured to receive an input of operations using voice).

The output device is implemented by any one of or a combination of two or more of all types of devices capable of outputting a result of processing performed by the controller 21. Non-limiting examples of the output device include an indicator lamp, a touch panel, a touch display, a speaker (e.g., a device configured to generate a voice output), a lens (non-limiting examples of which include devices configured to generate a three-dimensional (3D) output or a hologram output), and a printer.

The display 24 is implemented by any one of or a combination of two or more of various types of devices capable of providing display in accordance with display data written in a frame buffer. Non-limiting examples of the display 24 include a touch panel, a touch display, a monitor (non-limiting examples of which include a liquid crystal display and an organic electroluminescence display (OELD)), a head mounted display (HMD), and devices capable of displaying images, text information, and the like using projection mapping or holograms, or in the air (may optionally be a vacuum). Note that the display 24 may optionally be capable of displaying display data in 3D.

If the input/output device 23 is a touch panel, the input/output device 23 and the display 24 may have substantially the same size and shape and be arranged opposing each other.

The controller 21 includes a physically structured circuit for executing functions that are implemented in accordance with codes or commands included in a program, and is implemented by a data processing device embedded in hardware, for example, without limitation. Accordingly, the controller 21 may optionally be referred to as a “control circuit”.

Non-limiting examples of the controller 21 include a central processing unit (CPU), a microprocessor, a processor core, a multiprocessor, an ASIC (Application-Specific Integrated Circuit), and a FPGA (Field Programmable Gate Array).

The storage device 28 stores various programs and various types of data that are desired for the terminal 20 to operate. Non-limiting examples of the storage device 28 include various storage media such as an HDD (Hard Disk Drive), an SSD (Solid State Drive), a flash memory, a RAM (Random Access Memory), and a ROM (Read Only Memory). The storage device 28 may optionally be referred to as a “memory.”

The terminal 20 stores a program in the storage device 28, and the controller 21 executes the program to execute processing while serving as units that are included in the controller 21. That is, the program stored in the storage device 28 causes the terminal 20 to implement functions executed by the controller 21. The program may optionally be referred to as a “program module”.

The microphone 25 is used to input voice (acoustic) data. The speaker 26 is used to output voice (acoustic) data. The camera 27 is used to acquire moving image data.

(2) Hardware Configuration of Payment Management Server

FIG. 1 shows an example of the hardware configuration of the payment management server 10.

The payment management server 10 includes a controller (e.g., CPU) 11, a storage device 15, a communication I/F (interface) 14, an input/output device 12, and a display 13. The hardware constituent elements of the payment management server 10 are connected to each other via a bus B, for example, without limitation. Note that the hardware configuration of the payment management server 10 does not necessarily need to include all of the constituent elements. The hardware of the payment management server 10 may optionally be configured such that the display 13 is removable.

The controller 11 includes a physically structured circuit for executing functions that are implemented in accordance with codes or commands included in a program, and is implemented by a data processing device embedded in hardware, for example, without limitation.

The controller 11 is typically a central processing unit (CPU), and may optionally be a microprocessor, a processor core, a multiprocessor, an ASIC, or a FPGA. In the present disclosure, the controller 11 is not limited to these examples.

The storage device 15 stores various programs and various types of data that are desired for the payment management server 10 to operate. The storage device 15 is implemented by various storage media such as an HDD, an SSD, and a flash memory. However, in the present disclosure, the storage device 15 is not limited to these examples. The storage device 15 may optionally be referred to as a “memory”.

The communication I/F 14 transmits and receives various types of data via the network 30. The communication may be carried out in a wired or wireless manner, and may be based on any communication protocol that enables mutual communication to be carried out. The communication I/F 14 functions to communicate with various types of devices such as the terminal 20 via the network 30. The communication I/F 14 transmits various types of data to the various types of devices such as the terminal 20 in accordance with instructions from the controller 11. Further, the communication I/F 14 receives various types of data transmitted from the various types of devices such as the terminal 20 and conveys the data to the controller 11. The communication I/F 14 may also be simply referred to as a “communication device”. The communication I/F 14 may also be referred to as a “communication circuit” in cases where the communication I/F is constituted by a physically structured circuit.

The input/output device 12 is implemented by a device that inputs various operations that are made to the payment management server 10. The input/output device 12 is implemented by any one of or a combination of two or more of all types of devices capable of accepting input from a user and conveying information regarding the input to the controller 11. The input/output device 12 is implemented by hardware keys, a typical example of which is a keyboard, and a pointing device such as a mouse. Note that the input/output device 12 may optionally include a touch panel, a camera (e.g., a device configured to receive an input of operations via moving images), or a microphone (e.g., a device configured to receive an input of operations using voice). However, in the present disclosure, the input/output device 12 is not limited to these examples.

The display 13 is typically implemented by a monitor (non-limiting examples of which include a liquid crystal display and an organic electroluminescence display (OELD)). Note that the display 13 may optionally be a head mounted display (HMD) or the like. Note that the display 13 may optionally be capable of displaying display data in 3D. In the present disclosure, the display 13 is not limited to these examples.

(3) Configuration of Smart Speaker Management Server

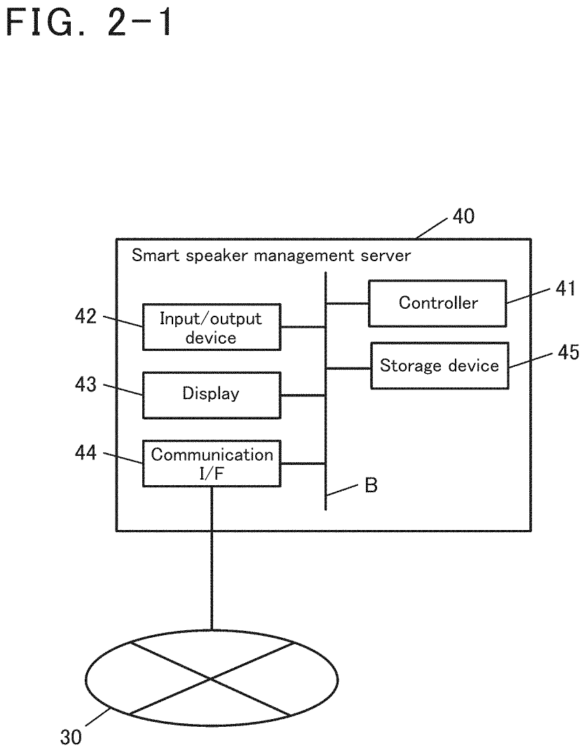

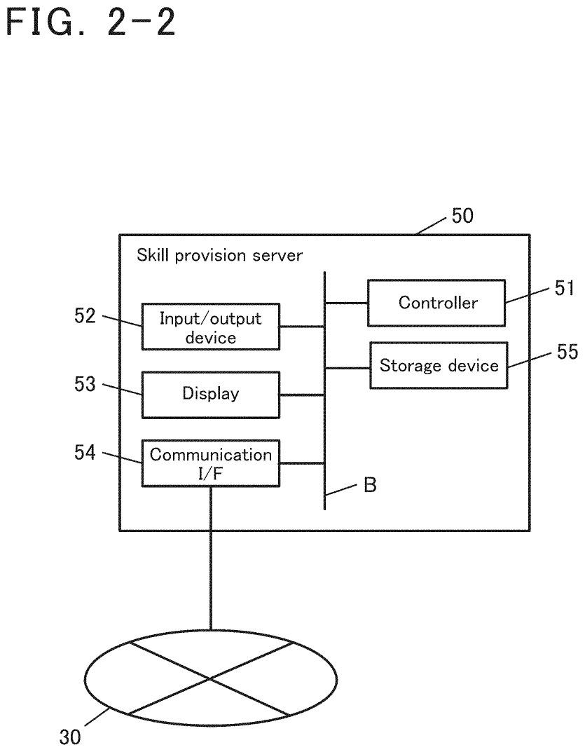

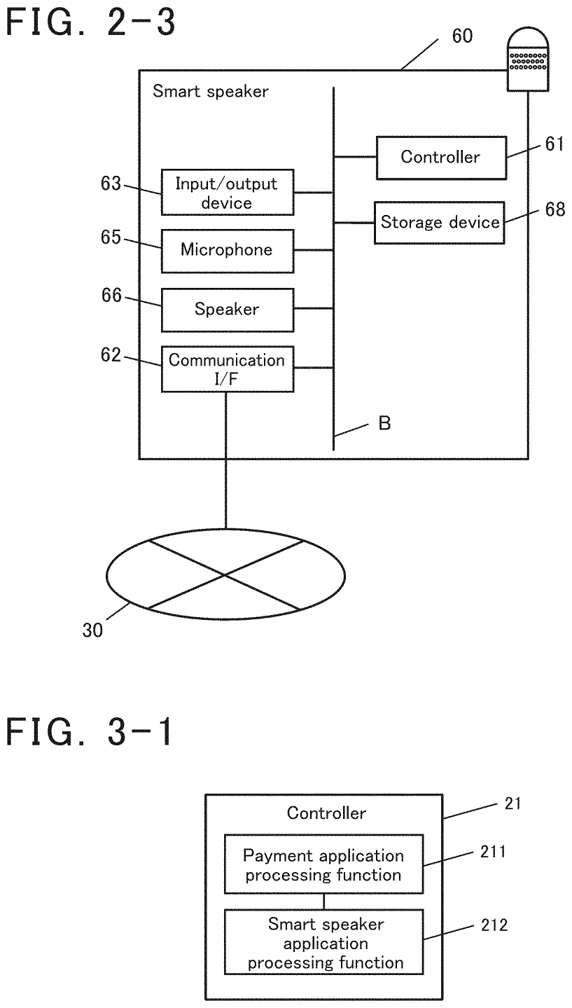

FIG. 2-1 shows an example of the hardware configuration of the smart speaker management server 40.

The smart speaker management server 40 includes a controller 41 (e.g., CPU), a storage device 45, a communication I/F (interface) 44, an input/output device 42, and a display 43. The hardware constituent elements of the smart speaker management server 40 are connected to each other via a bus B, for example, without limitation. Note that the hardware configuration of the smart speaker management server 40 does not necessarily need to include all of such constituent elements. The smart speaker management server 40 may optionally be configured such that the display 43 is removable, for example, without limitation.

For example, without limitation, the like parts and the like circuits constituting the functional portions of the smart speaker management server 40 can be the same as or substantially similar to those of the payment management server 10, and thus descriptions thereof will be omitted.

(4) Skill Provision Server Configuration

FIG. 2-2 shows an example of the hardware configuration of the skill provision server 50.

The skill provision server 50 includes a controller 51 (e.g., CPU), a storage device 55, a communication I/F (interface) 54, an input/output device 52, and a display 53. The hardware constituent elements of the skill provision server 50 are connected to each other via a bus B, for example, without limitation. Note that the hardware configuration of the skill provision server 50 does not necessarily need to include all of such constituent elements.

For example, without limitation, the parts, circuits, and the like constituting the functional portions of the skill provision server 50 can be the same as or substantially similar to those of the payment management server 10, and thus descriptions thereof will be omitted.

(5) Smart Speaker Configuration

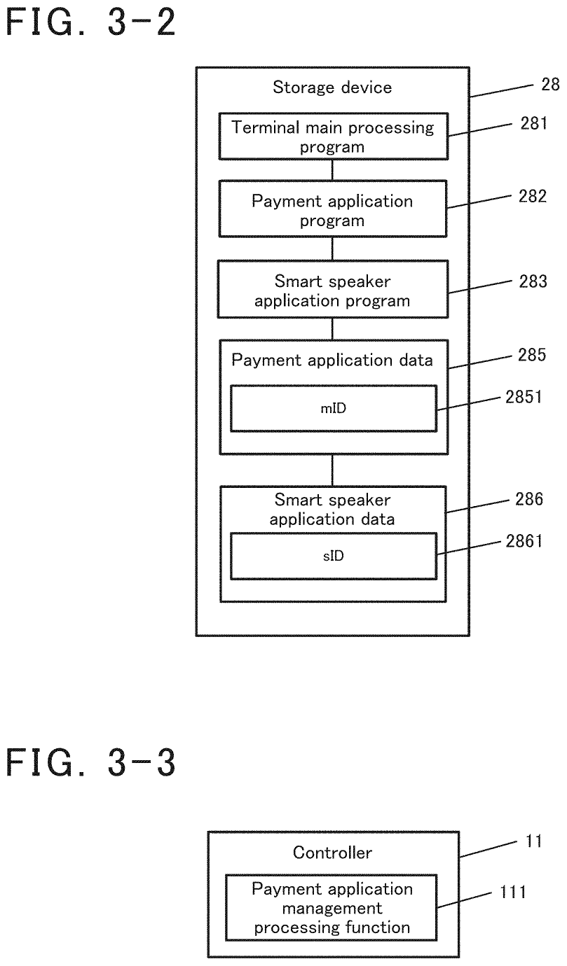

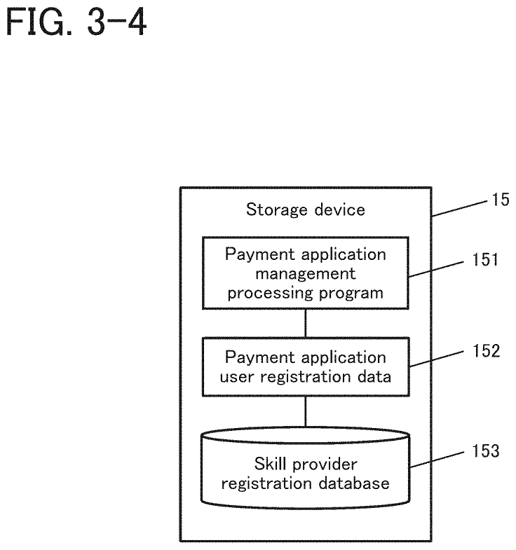

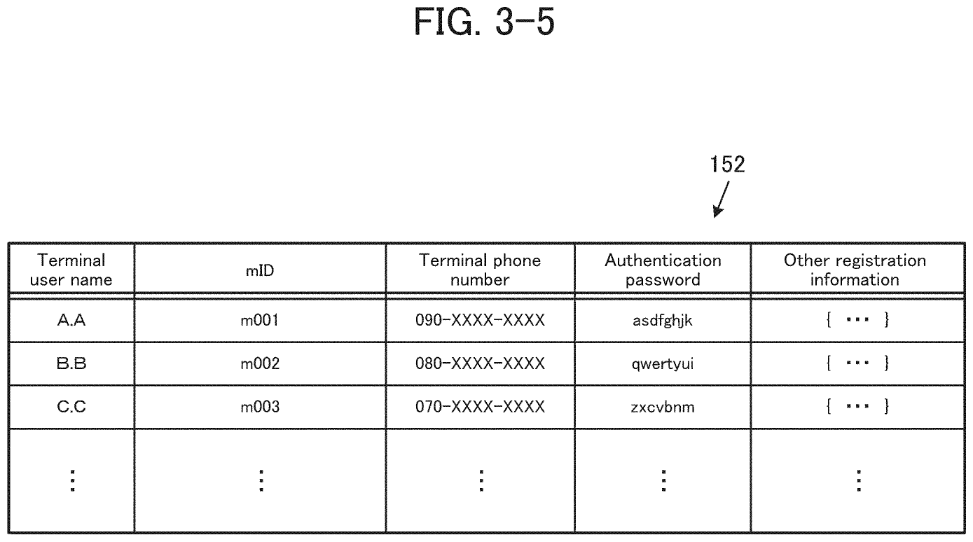

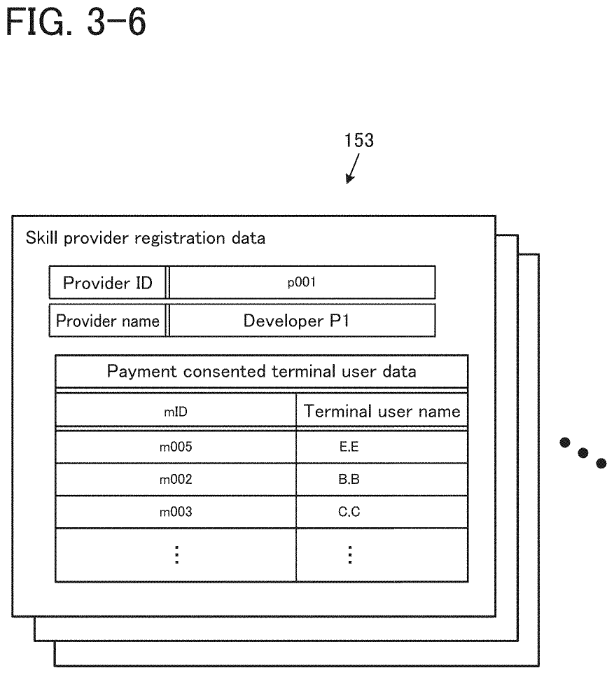

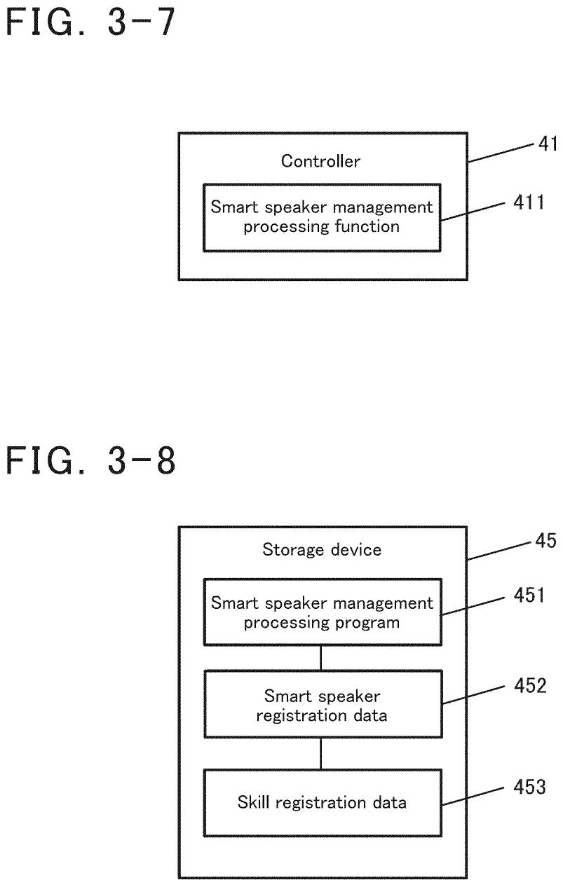

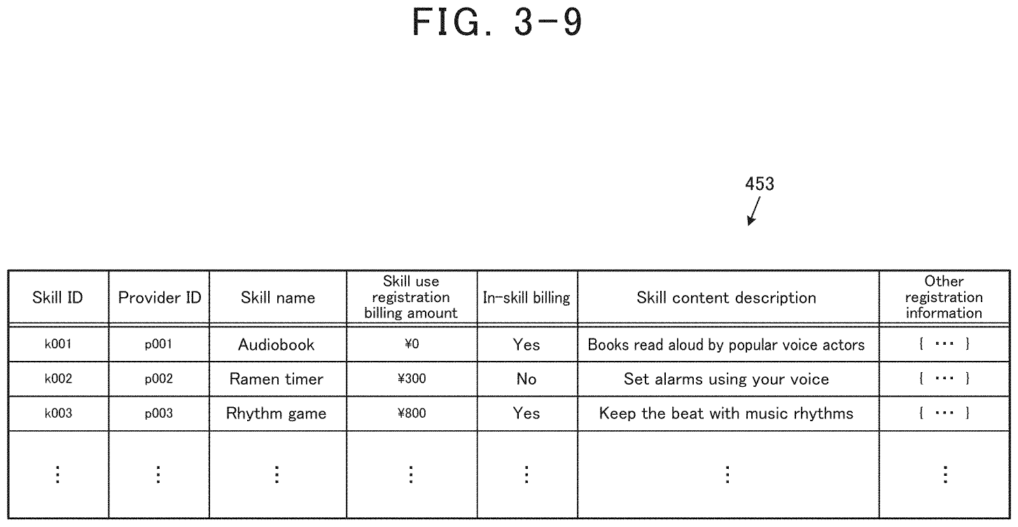

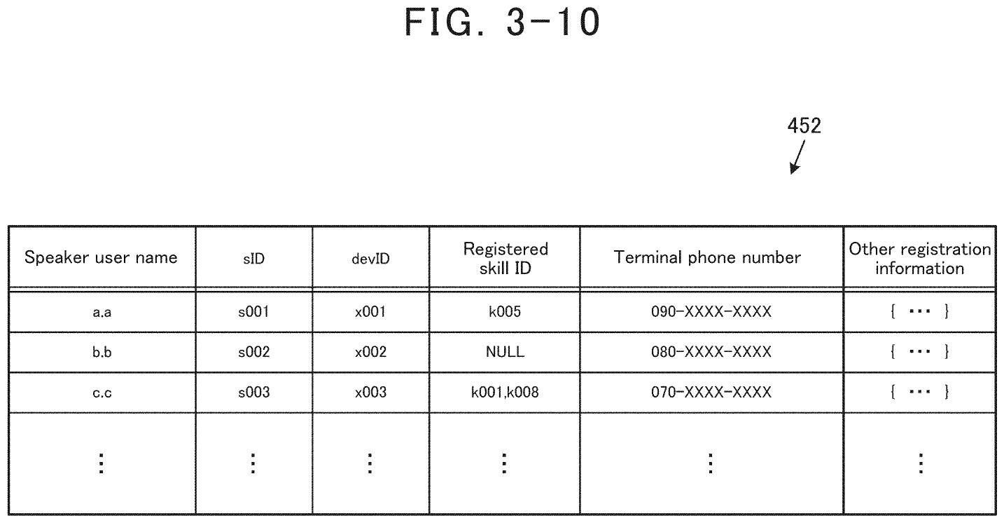

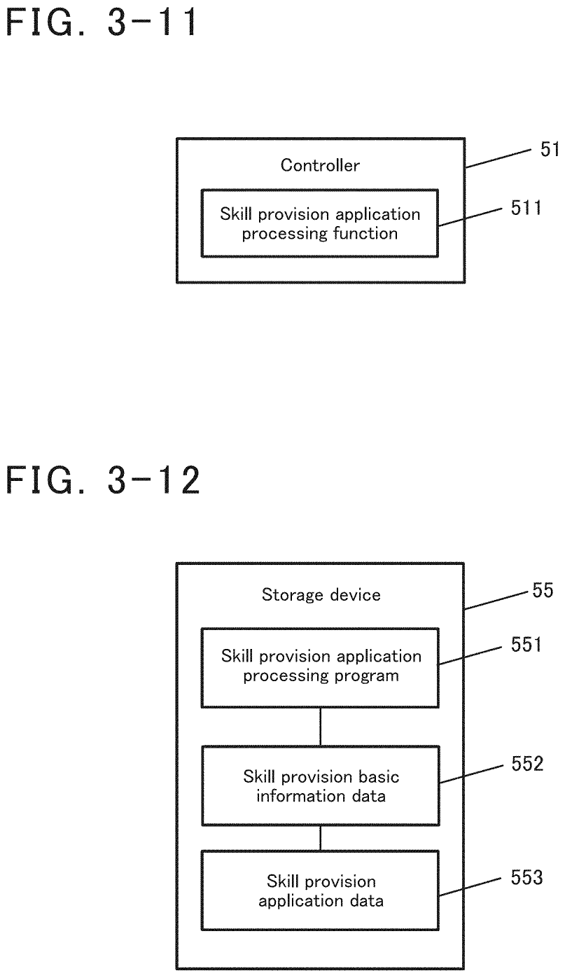

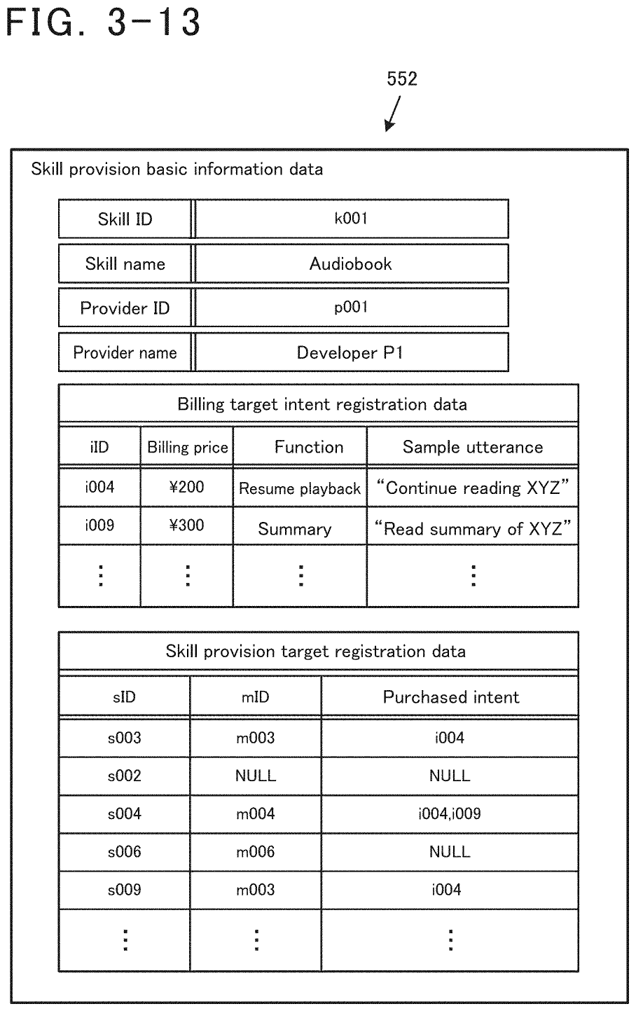

FIG. 2-3 shows an example of the hardware configuration of the smart speaker 60.

The smart speaker 60 includes a controller 61 (e.g., CPU: central processing unit), a storage device 68, a communication I/F 62 (interface), an input/output device 63, a microphone 65, and a speaker 66. The hardware constituent elements of the smart speaker 60 are connected to each other via a bus B, for example, without limitation. Note that the hardware configuration of the smart speaker 60 does not necessarily need to include all of such constituent elements. The smart speaker 60 may optionally be configured such that the input/output device 63 is removable, for example, without limitation. Further, the smart speaker 60 may include additional constituent elements not shown in FIG. 2-3. For example, without limitation, a display may optionally be added to the configuration.

For example, without limitation, the hardware configuration, the parts, circuits, and the like constituting the functional portions of the smart speaker 60 can be same as or substantially similar to those of the terminal 20, and thus descriptions thereof will be omitted.

(6) Other Remarks

The payment management server 10 stores the program in the storage device 15, and the controller 11 executes the program to execute processing while serving as units that are included in the controller 11. That is, the program stored in the storage device 15 causes the payment management server 10 to implement functions executed by the controller 11. The program may optionally be referred to as a “program module”.

This similarly applies to other devices.

Some example embodiments of the present disclosure will be described assuming that the example embodiments are implemented as a result of CPU(s) of the terminal 20 and/or the payment management server 10 executing the program.

This similarly applies to other devices.

Note that the controller 21 of the terminal 20 and/or the controller 11 of the payment management server 10 may optionally implement processing by using not only the CPU(s) including a control circuit, but also a logic circuit (hardware) or a dedicated circuit that is formed on an integrated circuit (an IC (Integrated Circuit) chip or an LSI (Large Scale Integration) chip or the like. Further, these circuits may optionally be implemented by one or more integrated circuits, and a plurality of types of processing described in the example embodiments may optionally be implemented by a single integrated circuit. LSI may be referred to as VLSI, super LSI, ultra LSI, or the like depending on the degree of integration. Accordingly, the controller 21 may optionally be referred to as a “control circuit”.

This similarly applies to other devices.

The program (non-limiting examples of which include a software program, a computer program, and a program module) in the example embodiments of the present disclosure may optionally be provided in a state where the program is stored in a computer-readable storage medium. The program can be stored in a “non-transitory tangible medium”. Further, the program may optionally be a program for implementing some of the functions described in the example embodiments of the present disclosure. Furthermore, the program may optionally be a differential file (differential program) that is configured to implement the functions described in the example embodiments of the present disclosure in combination with a program that is already recorded in a storage medium.

The storage medium may include one or more semiconductor-based or other integrated circuits (ICs, non-limiting examples of which include field programmable gate arrays (FPGAs) and application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM drives, secure digital cards, drives, any other appropriate storage media, and a suitable combination of two or more of these storage media. Where appropriate, the storage medium may be constituted by only a volatile storage medium or a non-volatile storage medium, or a combination of volatile and non-volatile storage media. Note that the storage medium is not limited to these examples, and may be any device or medium that is capable of storing the program. Further, the storage medium may optionally be referred to as a “memory”.

The payment management server 10 and/or the terminal 20 can implement functions of a plurality of functional units described in the example embodiments by reading the program stored in the storage medium and executing the read program.

This similarly applies to other devices.

The program according to some example embodiments of the present disclosure may optionally be provided to the payment management server 10 and/or the terminal 20 via any transmission medium (a communication network, broadcast waves, etc.) that is capable of transmitting the program. The payment management server 10 and/or the terminal 20 implement(s) the functions of the functional units described in the example embodiments by executing the program downloaded via the Internet or the like, for example, without limitation.

This similarly applies to other devices.

The example embodiments of the present disclosure can also be implemented in the form of a data signal in which the program is embodied through electronic transmission.

At least a portion of processing in the payment management server 10 and/or the terminal 20 may optionally be implemented through cloud computing constituted by one or more computers.

At least a portion of processing in the terminal 20 may optionally be carried out by the payment management server 10. In this case, the payment management server 10 may optionally carry out at least a portion of processing carried out by functional units of the controller 21 of the terminal 20.

At least a portion of processing in the payment management server 10 may optionally be carried out by the terminal 20. In this case, the terminal 20 may optionally carry out at least a portion of processing carried out by functional units of the controller 11 of the payment management server 10.

This similarly applies to other devices.

In the example embodiments of the present disclosure, configurations for determination are not essential unless explicitly mentioned otherwise, and desired (or alternatively, predetermined) processing may be activated in case a determination condition is satisfied, or desired (or alternatively, predetermined) processing may be activated in case a determination condition is not satisfied, without limitation thereto.

The program according to the present disclosure is implemented using a script language such as ActionScript or JavaScript (registered trademark), an object-oriented language such as Objective-C or Java (registered trademark), or a markup language such as HTML5, for example, although there is no limitation thereto.

### Some Example Embodiments

Various skills (e.g., applications and application software for smart speakers) related to services used through the smart speaker 60 have been developed in recent years. The user of the smart speaker 60 can receive various services by using such skills.

For example, without limitation, in the example embodiment described below, in the case where the user of the smart speaker 60 uses a skill to receive a fee-based (paid) service, payment of the service usage fee is made from an account of the terminal 20 or the user of the terminal 20 in accordance with an account instruction from the business operator that developed or provides the skill (or an instruction from the skill provision server 50).

In the example embodiment described below, during payment of the service usage fee, payment by electronic money is performed using a payment application executed by the terminal 20.

Hereinafter, a business operator that developed or provides a skill for the smart speaker 60 is referred to as a “skill provider”. In FIG. 1, the skill providers are shown as “developer P1”, “developer P2”, and so on.

Further, a business operator that provides a payment service or settlement service using a payment application is referred to as a “settlement service business operator”.

A business operator that operates (develops, etc.) the smart speaker 60 is referred to as a “smart speaker business operator”.

The settlement service business operator may optionally be described as a payment application business operator or the business operator of the payment management server 10.

Similarly, the skill provider may optionally be described as the business operator of the skill provision server 50.

Further, the smart speaker business operator may optionally be described as the business operator of the smart speaker management server 40.

The settlement service business operator and the smart speaker business operator may optionally be the same business operator.

The smart speaker business operator and the skill provider may optionally be the same business operator.

In this example embodiment, it is assumed that various services related to payment are provided in a payment application, and the payment management server 10 is operated and managed by a settlement service business operator. In the following, as one example, the name of the payment application is referred to as “Payment App,” and is illustrated and described as such.

Further, in this example embodiment, it is assumed that various services related to the initial setting of the smart speaker 60 and the addition of skills are provided in a smart speaker application executed by the terminal 20, and the smart speaker management server 40 is operated and managed by a smart speaker business operator. In the following, as one example, the name of the smart speaker application is referred to as “Smart Speaker App,” and is illustrated and described as such.

In this example embodiment, “electronic money” is electronic money that is distinguishable from physical money, and is electronic money that is in the possession of the terminal 20 or the user of the terminal 20 and managed in the payment application, as well as being payable to the skill provider by the user of the terminal 20 (or by the terminal 20) in accordance with an account instruction from the skill provider. This electronic money may optionally be described as “electronic cash”.

The following are examples of service usage fee systems used when the user of the smart speaker 60 uses a skill in this example embodiment.

(a) Payment at the start of skill use (paid sale/package sale of skill)

(b) Individual payment for content, functions, or the like provided within the skill while using the skill (known as “in-skill (in-app) billing”)

(c) Payment of a flat-rate usage fee for a certain period for content, functions, or the like provided within the skill while using the skill (so-called subscription).

(d) Combination of two or more of the above (a) to (c)

Functional Configuration

(1) Functional Configuration of Terminal

FIG. 3-1 is a diagram showing functions realized by the controller 21 of the terminal 20 according to an example embodiment.

For example, without limitation, the controller 21 includes a payment application processing function 211 and a smart speaker application processing function 212 as main functions.

The payment application processing function 211 has a function of performing processing based on various functions of the payment application in accordance with a payment application program 282 stored in the storage device 28.

The smart speaker application processing function 212 has a function of performing processing based on various functions of a smart speaker application, such as initial smart speaker registration and the addition of skills to the smart speaker in accordance with a smart speaker application program 283 (see FIG. 3-2) stored in the storage device 28.

FIG. 3-2 is a diagram showing an example of information stored in the storage device 28 of the terminal 20 according to an example embodiment.

For example, without limitation, the storage device 28 stores a terminal main processing program 281 executed as terminal main processing, the payment application program 282 executed as payment application processing, payment application data 285, the smart speaker application program 283 to be executed as smart speaker application processing, and smart speaker application data 286.

The term “payment application” used in this description means the payment application program 282. Similarly, the term “smart speaker application” used in this description means the smart speaker application program 283.

Note that the payment application may be provided as a single application that does not have a so-called messaging service (MS) function, or may be provided as a multi-function application that has a messaging service function. Further, a messaging service may optionally include an instant messaging service (IMS) that enables the transmission and reception of content such as simple messages between terminals 20.

Further, the payment application may be provided as a single application that does not have a so-called social networking service (SNS) function, or may be provided as a multi-function application that has an SNS function.

Note that a messaging service (including an instant messaging serve) can be considered to be one form (one aspect) of an SNS. Therefore, distinction may or may not be made between a messaging service and an SNS.

Further, a settlement application may optionally be provided instead of a payment application.

The payment application data 285 is data for realizing various functions of the payment application, and includes, but is not limited to, payment application ID data 2851, which is data indicating an identifier (ID) in the payment application. In the figures and in the following description, the payment application ID is referred to as “mID.”

The smart speaker application data 286 is data for realizing various functions of the smart speaker application, and includes, but is not limited to, smart speaker application identifier (ID) data 2861, which is data indicating an ID in the smart speaker application. In the figures and in the following description, the smart speaker application ID is referred to as “sID.”

(2) Functional Configuration of Smart Speaker

For example, without limitation, the controller 61 of the smart speaker 60 includes a smart speaker main processing function (not shown) as a main function.

The smart speaker main processing function has a function of performing processing based on various functions of the smart speaker in accordance with a smart speaker main processing program (not shown) stored in the storage device 68.

For example, without limitation, the storage device 68 of the smart speaker 60 stores the smart speaker main processing program (not shown) executed as a smart speaker main processing and smart speaker device ID data (a non-limiting example of a smart speaker identifier), which is identification information regarding the smart speaker. In the figures and in the following description, the smart speaker device ID is referred to as “devID” (see FIG. 3-10).

(3) Functional Configuration of Payment Management Server

FIG. 3-3 is a diagram showing functions realized by the controller 11 of the payment management server 10 according to an example embodiment.

For example, without limitation, the controller 11 includes a payment application management processing function 111 as a main function.

The payment application management processing function 111 has a function of executing payment application management processing for managing data and the like related to the payment application executed on the terminal 20 in accordance with a payment application management processing program 151 stored in the storage device 15.

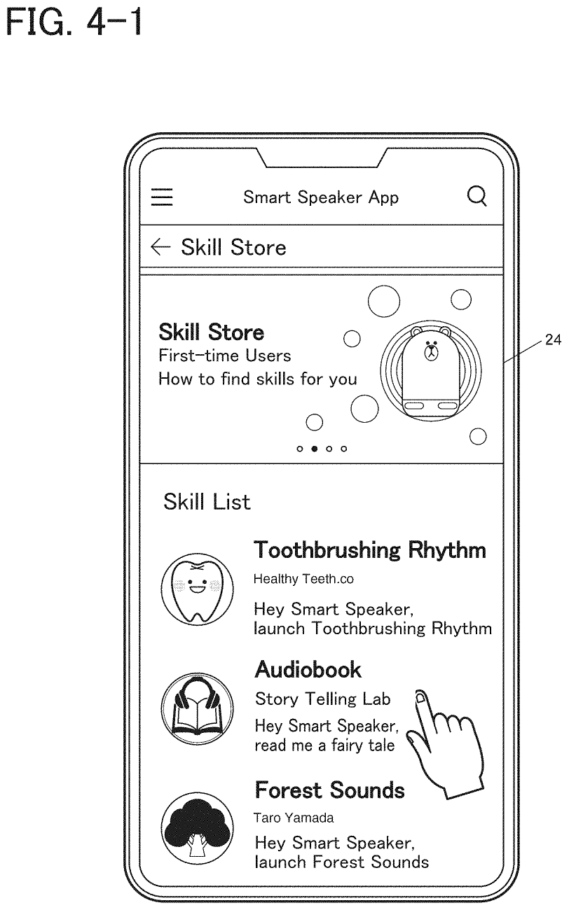

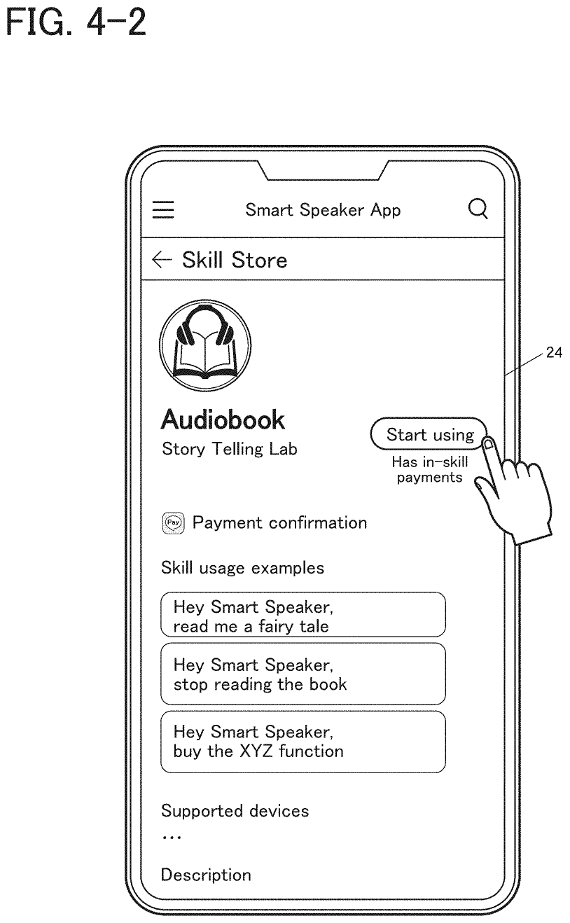

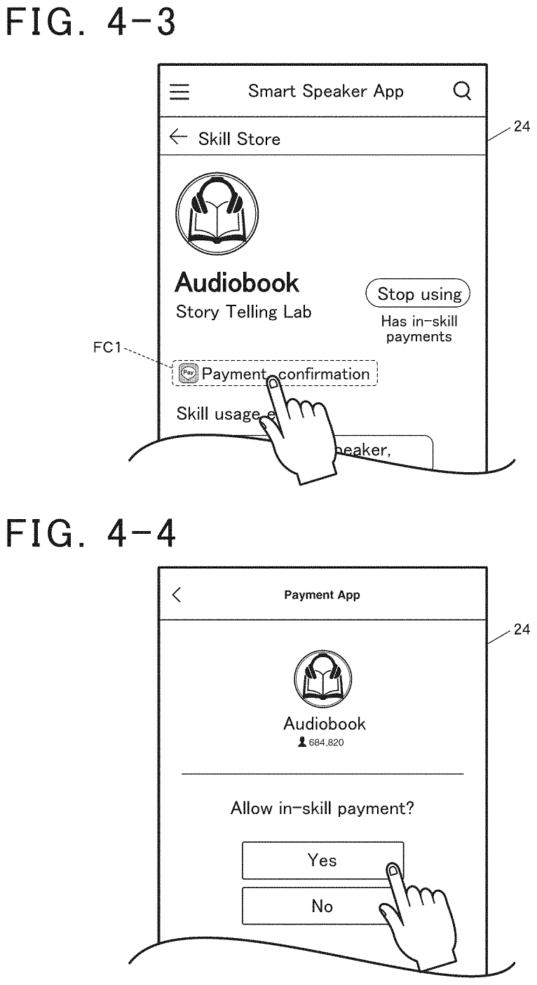

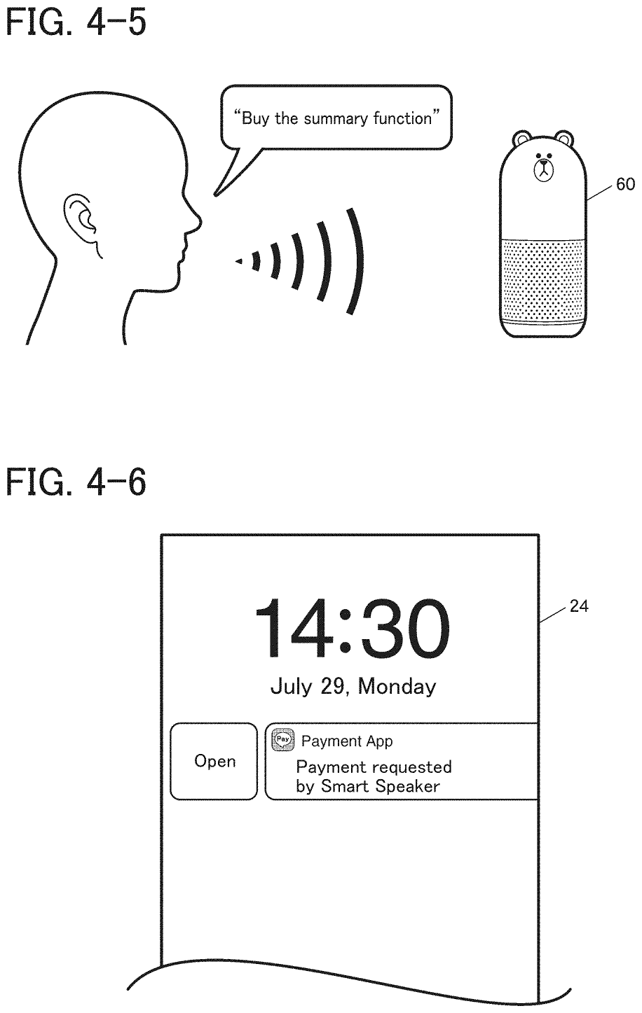

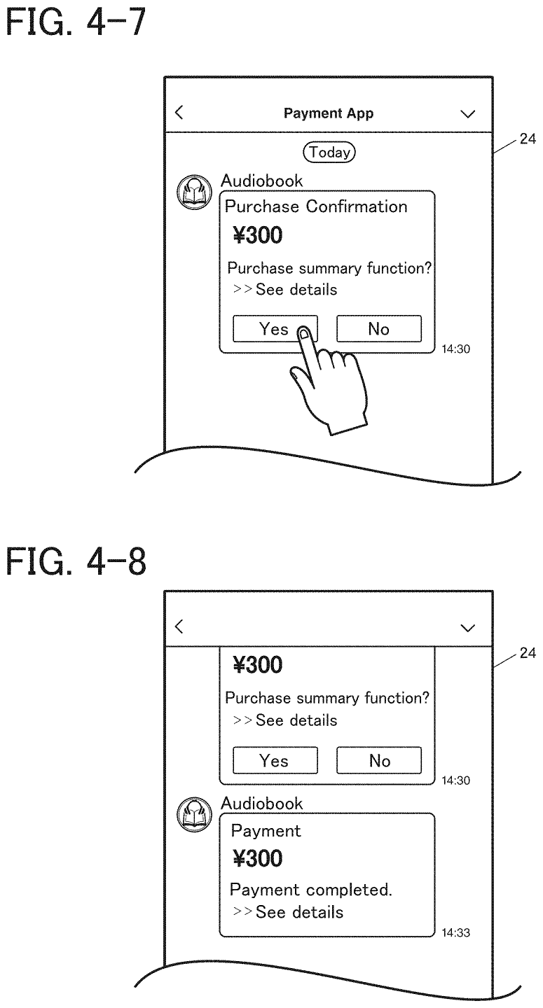

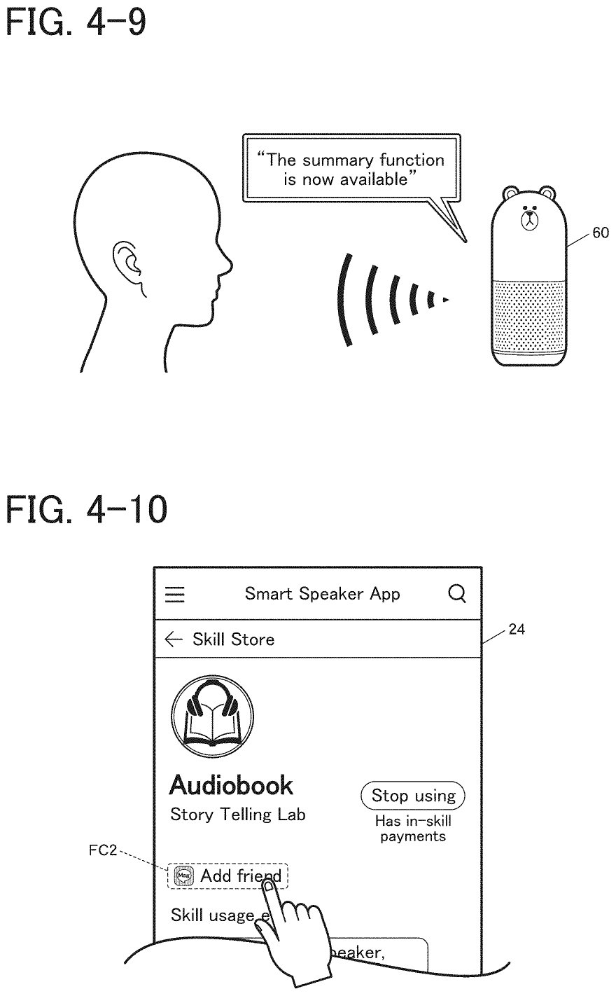

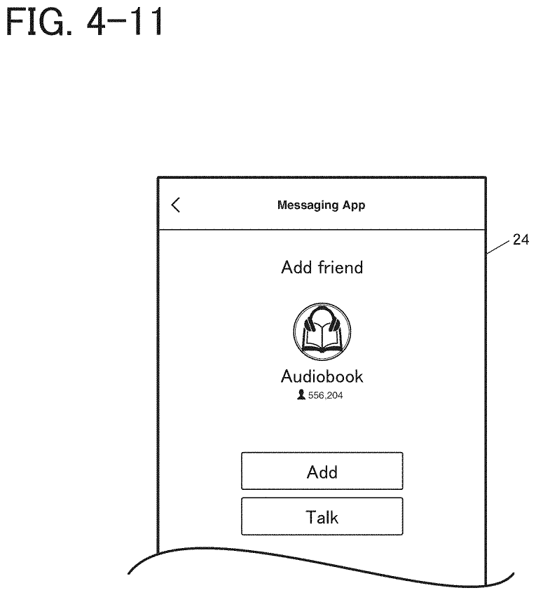

FIG. 3-4 is a diagram showing information stored in the storage device 15 of the payment management server 10 according to an example embodiment.

For example, without limitation, the storage device 15 stores not only the payment management server main processing program executed as the main processing of the payment management server 10, but also the payment application management processing program 151 executed as payment application management processing.

For example, without limitation, the storage device 15 stores payment application user registration data 152 and a skill provider registration database 153.

The payment application user registration data 152 is registration data regarding the terminal 20 that uses the service provided by the payment application or regarding the user of the terminal 20, and an example of the data structure is shown in FIG. 3-5.

For example, without limitation, a terminal username, an mID, a terminal phone number, an authentication password, and other registration information are stored in association with each other in the payment application user registration data 152.

The terminal username is the name of the user of the terminal 20 that uses the service provided by the payment application, and is the name registered when the user of the terminal 20 first uses the payment application, for example.

The mID is the payment application ID described above, and functions as identification information for identifying the terminal 20 or the user of the terminal 20. The mID is uniquely set by the payment management server 10 for each terminal 20 that uses the payment application or for each user of the terminal 20.

The terminal phone number is the phone number of the terminal 20 of the user that has the corresponding terminal username, and is the phone number of the terminal 20 that is first registered when the user of the terminal 20 uses the payment application, for example.

The terminal phone number is an example of identification information for identifying the terminal 20.

The authentication password is a password for authentication that needs to be input to the terminal 20 in authentication processing executed when using various functions provided as functions of the payment application in the terminal 20 of the user having the corresponding terminal username, and is a password set by the user, for example.

The other registration information is other registration information regarding the user that has the corresponding terminal username, and for example, without limitation, is information such as a user icon image, which is image data for an icon used by the user in the payment application.

The above-described various types of user information may be stored and managed by the payment management server 10 as user information that is shared between the payment application and another application that can be provided by the payment management server 10, or may be stored and managed by the payment management server 10 as separate user information.

The skill provider registration database 153 is a database that stores management data related to skill providers that are affiliated with settlement service business operators (e.g., for which settlement for a service that uses a skill is performed through a settlement service business operator), and an example of the data structure is shown in FIG. 3-6.

The skill provider registration database 153 stores skill provider registration data as management data for each skill provider.

For example, without limitation, the skill provider registration data stores a provider ID, a provider name, and payment consented terminal user data (e.g., user data of a terminal that has consented to payment).

The provider ID is an identifier that functions as identification information for identifying the skill provider. The name of the skill provider that corresponds to the provider ID is stored in the provider name.

In the payment consented terminal user data, the mID of the terminal 20 that has consented to payment (e.g., permitted payment) to the skill provider corresponding to the provider ID in payment consent confirmation processing described later is stored in association with a terminal user name.

For example, in FIG. 3-6, it is shown that the terminal with the terminal user name “E.E” and identified by the mID “m005”, the terminal with the terminal user name “B.B” and identified by the mID “m002”, and the terminal with the terminal user name “C.C” and identified by the mID “m003” have consented to payment billed by the skill provider that has the provider name “developer P1” and has the provider ID “p001” as an identifier.

Note that if the payment application is a multi-function application that has a messaging service (MS) function, the skill provider registration database 153 may be a database for managing skill provider groups.

Here, “skill provider group” refers to a group of skill providers in a messaging application for a business operator.

(4) Functional Configuration of Smart Speaker Management Server

FIG. 3-7 is a diagram showing functions realized by the controller 41 of the smart speaker management server 40 according to an example embodiment.

For example, without limitation, the controller 41 includes a smart speaker management processing function 411 as a main function.

The smart speaker management processing function 411 has a function of executing smart speaker management processing that bridges commands and data processing between the smart speaker 60 and the skill provision server 50 in accordance with a smart speaker management processing program 451 stored in the storage device 45. Further, the smart speaker management processing function 411 has a function of executing smart speaker management processing for managing data and the like related to the smart speaker application executed by the terminal 20.

FIG. 3-8 is a diagram showing information stored in the storage device 45 of the smart speaker management server 40 according to an example embodiment.

For example, without limitation, the storage device 45 stores the smart speaker management processing program 451 executed as the main processing of the smart speaker management server 40.

Further, for example, without limitation, the storage device 45 stores smart speaker registration data 452 and skill registration data 453.

The skill registration data 453 is skill-related registration data related to the skill provider or the skill provision server 50 that provides a smart speaker service, and an example of the data structure is shown in FIG. 3-9.

For example, without limitation, a skill ID, a provider ID, a skill name, a skill use registration billing amount, an in-skill billing, a skill content description, and other registration information are stored in association with each other in the skill registration data 453.

The skill ID is an ID that functions as identification information for identifying the skill provision server 50 or the skill provided by the skill provision server 50, and is an ID that is uniquely set by the smart speaker management server 40 for each skill provision server 50 that provides a skill (or for each skill).

The provider ID is an ID that functions as identification information for identifying the skill provider that operates the skill provision server 50 or identifying the skill provider that developed and operates the skill provided by the skill provision server 50, and is an ID that is uniquely set by the smart speaker management server 40 for each skill provider (or for each skill).

The skill name is the name of the skill identified by the skill ID or the name of the service provided by the skill. The skill content description includes a description of the skill function, a description of the service content, or the like.

The skill use registration billing amount indicates the amount charged at the time of use registration that enables the skill identified by the skill ID in the smart speaker 60 to be used. If the skill use registration billing amount is “¥0”, this means that the skill identified by the skill ID can be registered for use free of charge.

In-skill billing includes information on whether or not payment for a usage fee is required during usage of the skill identified by the skill ID in the smart speaker 60, and non-limiting examples include payment for the unlocking of functions within the skill, the addition of content, and a service provided through the skill.

The other registration information is other registration information regarding the skill, and non-limiting examples include a skill icon image, which is image data of an icon used in the smart speaker application, and the skill provider name (provider name) identified by the provider ID.

For example, it is shown in FIG. 3-9 that in the case of the skill with the skill name “Audiobook” identified by the skill ID “k001”, skill usage registration is free of charge, but payment within the skill may be needed. It is also shown that in the case of the skill with the skill name “Ramen Timer” identified by the skill ID “k002”, it is needed to pay “¥300” to register usage of the skill, but no payment is needed during subsequent use of the skill.

The following describes details for the case where the skill use registration billing amount is “¥0” and the existence of in-skill billing is “yes” (e.g., payment is not needed at the start of skill use, but individual payment is needed for content or functions provided in the skill during usage of the skill), and other cases will be described later as variations.

The smart speaker registration data 452 is registration data regarding the smart speaker 60 that uses a smart speaker service or the user of the smart speaker 60, and an example data configuration of which is shown in FIG. 3-10.

For example, without limitation, in the smart speaker registration data 452, a speaker username, an sID, a devID, a registered skill ID, a terminal phone number, and other registration information are stored in association with each other.

The speaker username is the name of the user of the smart speaker 60 that uses a smart speaker service, and for example is the name given when the user of the smart speaker 60 first registers the smart speaker 60 by using the smart speaker application of the terminal 20.

The sID is an ID that functions as identification information for identifying the terminal 20 or the user of the terminal 20, and is an ID that is uniquely set by the smart speaker management server 40 for each terminal 20 that uses the smart speaker application or for each user of the terminal 20.

The devID is an ID that functions as identification information for identifying the smart speaker 60, and is an ID that is uniquely set for each smart speaker 60.

For example, without limitation, the devID is transmitted from the smart speaker 60 when the user of the smart speaker 60 first registers the smart speaker using the smart speaker application of the terminal 20. Then, when the smart speaker management server 40 receives the devID, the smart speaker management server 40 stores the received devID in association with the sID in the smart speaker registration data 452.

At that time, multiple devIDs may optionally be associated with the same sID.

The registered skill ID is the skill ID for which the user of the smart speaker 60 has registered skill usage (skill addition) using the smart speaker application of the terminal 20 or the smart speaker 60. Note that the registered skill ID is empty when the smart speaker is registered (e.g., it has a null value indicating that no data has been input to the registered skill ID). Further, a plurality of skill IDs may be stored in the registered skill ID.

The terminal phone number is the phone number of the terminal 20 of the user that has the corresponding terminal username, and for example, is the phone number of the terminal 20 that is first registered when the user of the terminal 20 uses the smart speaker application.

The terminal phone number is an example of identification information for identifying the terminal 20.

The other registration information is other registration information regarding the user that has the corresponding speaker username.

For example, it is shown in FIG. 3-10 that the user with the speaker username “a.a” identified by sID “s001” has registered usage of the smart speaker identified by devID “x001”, and registered usage of the skill with the skill ID “k005”. In other words, it is shown that the skill with the skill ID “k005” can be used by the smart speaker with the devID “x001”.

(5) Functional Configuration of Skill Provision Server

FIG. 3-11 is a diagram showing functions realized by the controller 51 of the skill provision server 50 according to an example embodiment.

For example, without limitation, the controller 51 includes a skill providing application processing function 511 as a main function.

The skill providing application processing function 511 has a function of executing in-skill processing that is based on an intent transmitted from the smart speaker management server 40, in accordance with a skill providing application processing program 551 stored in the storage device 55, and transmitting the processing result to the smart speaker management server 40. The skill providing application processing function 511 also has a function of transmitting settlement request information generated when using a skill (through the use of a skill) to the payment management server 10, executing in-skill processing in accordance with the settlement result, and transmitting the processing result to the smart speaker management server 40.

FIG. 3-12 is a diagram showing an example of information stored in the storage device 55 of the skill provision server 50 according to an example embodiment.

For example, without limitation, the storage device 55 stores the skill providing application processing program 551 executed as the main processing of the skill provision server 50.

For example, without limitation, the storage device 55 also stores skill provision basic information data 552 and skill provision application data 553.

The skill provision application data 553 describes what kind of processing is to be executed based on an intent transmitted from the smart speaker management server 40 and what kind of processing result is to be transmitted, for each intent and each slot.

The skill provision basic information data 552 is registration data regarding a skill provided by the skill provision server 50, and an example of the data structure is shown in FIG. 3-13.

For example, without limitation, the skill provision basic information data 552 includes a skill ID, a skill name, a provider ID, a provider name, billing target intent data, and skill provision target registration data.

The skill ID, the skill name, and the provider ID are the same as in the skill registration data 453.

The provider name is the name of the skill provider that developed or provides the skill of the smart speaker 60, or manages and operates the skill provision server 50.

For example, without limitation, in the billing target intent registration data, an iID, a billing price, a function, and a sample utterance example are stored in association with each other.

The iID is an ID that functions as identification information for identifying an intent within the skill. The billing target intent data indicates which of the iIDs corresponds to an intent that needs billing to the smart speaker user for using the intent (e.g., processing of the intent).

The billing price is the payment amount to be paid to use the intent identified by the iID that needs billing. Further, the function indicates an overview (or a description) of the function related to the processing of the intent, and the sample utterance example indicates an example of a vocal operation instruction request given to the smart speaker 60 in order to use the intent.

For example, it is shown in FIG. 3-13 that in order to use the intent for the summarization function corresponding to the sample utterance example “read a summary of xxx” identified by the iID “i009” (here, “xxx” is a slot, and in this intent is the title data of the book that is to be read aloud such as “The Night of the Milky Way Train” or “No Longer Human”, for example), the user of the smart speaker 60 will be charged a billing price of “¥300” to use the intent.

For example, without limitation, in the skill provision target registration data, an sID, an mID, and a purchased intent are stored in association with each other.

The sID is an sID used when the user of the smart speaker 60 registers the use of the skill using the smart speaker application of the terminal 20.

The mID is an mID used in the payment application of the terminal 20 related to the sID, which is obtained in payment consent confirmation processing to be described later. Note that if payment consent processing has not been completed, the mID has a null value indicating that no data has been entered.

The purchased intent indicates the iID of an intent for which in-skill purchase processing has been completed, among the intents stored in the billing target intent data. If in-skill purchase processing has not been completed, the purchased intent has a null value indicating that no data has been entered. Further, the purchased intent may store the iIDs of a plurality of intents for each of which in-skill purchase processing has been completed.

For example, it is shown in FIG. 3-13 that the speaker user of the smart speaker application identified by sID “s003” and the terminal user of the payment application identified by mID “m003” have been linked through payment consent confirmation processing.

It is also shown that the intent with the iID “i004” (resume playback function) in the “Audiobook” skill has been enabled (is available) in the smart speaker 60 with the devID identified by sID “s003”.

Similarly, it is shown that the speaker user of the smart speaker application identified by sID “s002” can use the non-billed intent of the “Audiobook” skill but has not completed payment consent confirmation processing, and therefore the billing-needed intent (e.g., an intent to which billing is needed) has been disabled (cannot be used).

Note that although the skill provision basic information data 552 shows an example of an intent as the billing target, there is no limitation to this. As another example, it may be set that billing is needed in order to use a specific slot in the intent.

For example, it is possible that in the intent for the read-aloud function with the sample utterance example “Read aloud xxx” (xxx is the slot), the billing price “¥600” is needed to read aloud a book titled “The Night of the Milky Way Train”, and the billing price “¥400” is needed to read aloud a book titled “No Longer Human”.

Further, a service fee for an external service processed with the intent (e.g., a taxi fee calculated as the processing result of a “call taxi” intent or a pizza fee calculated as the processing result of an “order pizza delivery” intent) may be used as the billing price.

An intent whose billing price is such a service fee is an intent that is enabled only if the sID and the mID are linked. Because the service fee is incurred each time the intent is processed, an intent whose billing price is a service fee can be used even if not stored as a purchased intent.

In this way, the skill provision server 50 holds (stores) mIDs (a non-limiting example of an account (e.g., a payment application ID) and sIDs (a non-limiting example of a second account, e.g., a smart speaker application ID) in association with each other. By specifying the mID that is associated with an sID, the account to be used for settlement can be easily and appropriately specified based on the second account.

Examples of Display Screens, Usage Examples

FIG. 4-1 is a diagram showing a screen displayed on the display 24 of the terminal 20 according to an example embodiment. This screen is an example of the screen of a smart speaker application (smart speaker App), and shows descriptions regarding the skill store and a list of skills (skill list), for example, without limitation.

Information about multiple skills (hereinafter referred to as “skill information”) is listed in the skill list. For example, without limitation, the information displayed for each skill as the skill information includes a skill model image (skill schematic image), a skill name (“tooth brushing rhythm”, “Audiobook”, “forest sound”, etc.), the creator of the skill, and a brief description of how to use the skill. The user can select a skill by touching the display area of the corresponding skill information.

For example, when the skill information display area for “Audiobook” in FIG. 4-1 is tapped by the user, the screen shown in FIG. 4-2 is displayed. For example, without limitation, in the case of the “Audiobook” skill, the screen shows a button indicating “start using” for the user to start using the skill, a payment method for a usage fee related to the skill (in this example embodiment, a payment application), a detailed description of how to use the skill, supported devices, and the like.

For example, when the button showing “start using” in FIG. 4-2 is tapped by the user, the skill can be used in the body of the smart speaker 60, and as shown in FIG. 4-3, for example, the button text changes from “start using” to “stop using”, and the button indicating “start using” for the user to start using the skill changes from the active state to the inactive state.

In FIG. 4-3, a payment confirmation icon FC1 for confirming payment (settlement) of the usage fee using the payment application is displayed under the skill creator information for “Audiobook”. For example, without limitation, if the payment confirmation icon FC1 is tapped by the user, the payment application is started (executed) on the terminal 20, and the screen shown in FIG. 4-4 is displayed, for example.

The screen in FIG. 4-4 is a payment application screen, and shows confirmation information for asking whether or not the user consents to payment (settlement) within the “Audiobook” skill, in association with the “Audiobook” skill previously selected by the user. In this display example, the screen also shows the message “Allow in-skill payment?”, a button showing “Yes” for the user to operate if he/she consents, and a button showing “No” for the user to operate if he/she does not consent.

If the button showing “Yes” is tapped by the user, the user consents to in-skill payment. This allows payments within the “Audiobook” skill to be made using a payment application.

On the other hand, it is possible to implement a in which in-skill payment is automatically consented to when the button showing “start using” in the screen in FIG. 4-2 is tapped by the user.

Further, in this example, the total number of users who have consented to pay for the skill “Audiobook” is displayed in the area under the skill name “Audiobook”. For example, without limitation, this calculation can be performed by the payment management server 10.

It should be noted that this calculation and the display of the total number of users are not essential and can be omitted.

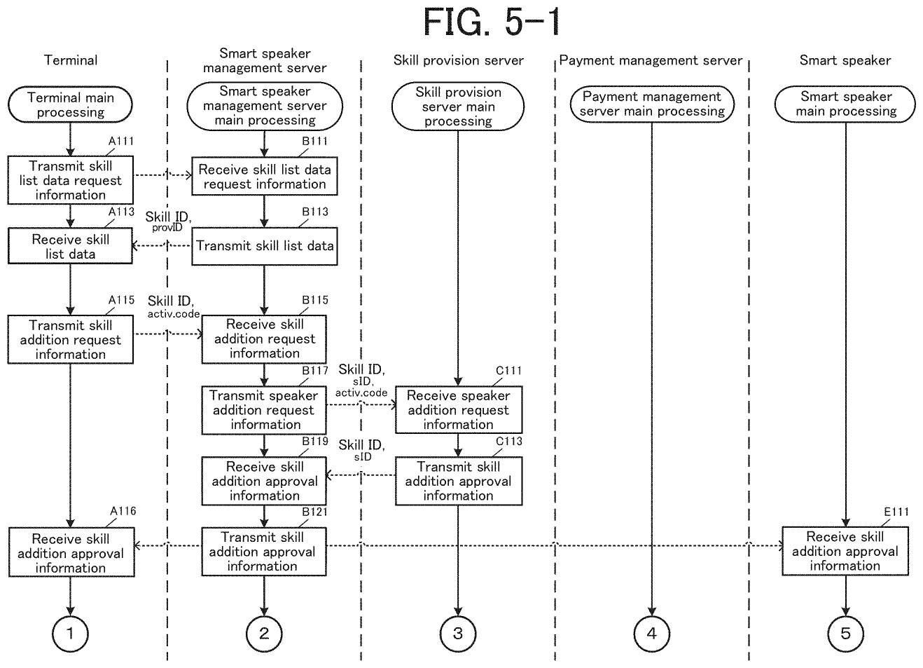

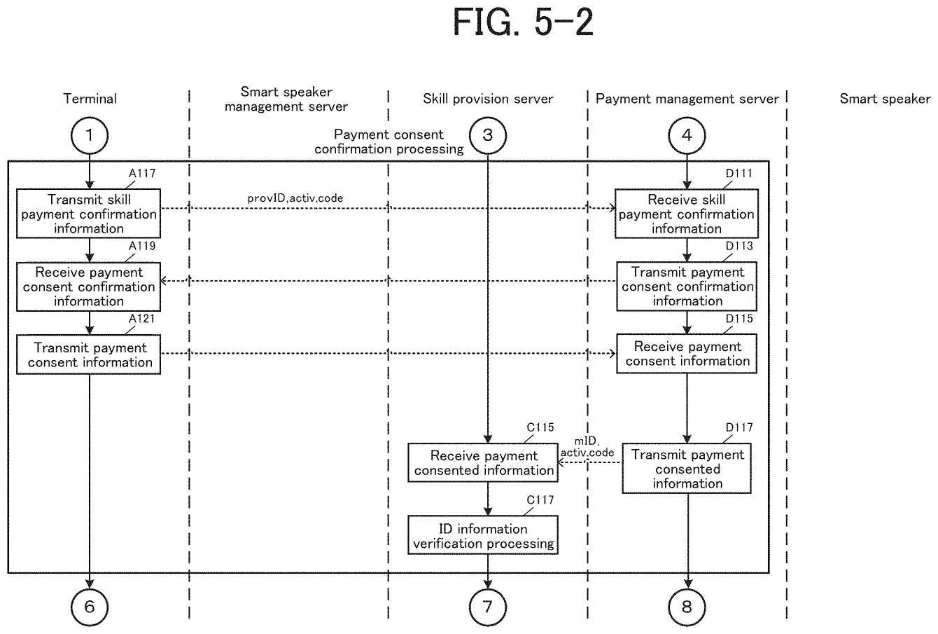

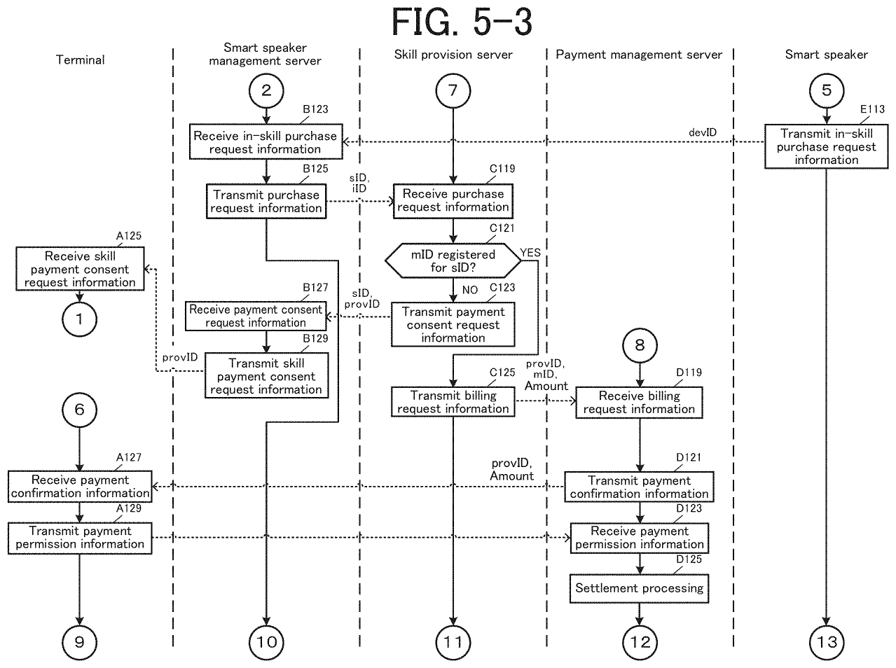

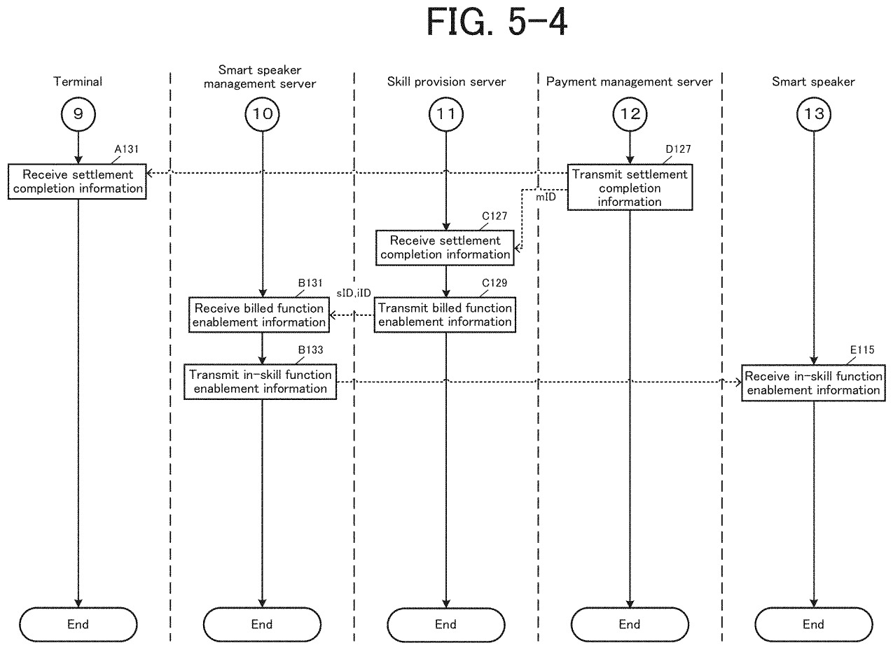

FIG. 4-5 is a diagram showing usage of the smart speaker 60 according to an example embodiment.

This example shows a case in which the user starts using the above-mentioned “Audiobook” skill and consents to in-skill payment. This example shows the case where the user says the phrase “buy the summary function” to the smart speaker 60 (makes an utterance). For example, without limitation, the “summary function” is one of the functions in the skill “Audiobook,” and is an example of a paid function.

FIG. 4-6 is a diagram showing information notified to the terminal 20 based on the user's utterance to the smart speaker 60 in FIG. 4-5, according to an example embodiment.

After the “Audiobook” skill starts to be used, if the user says the phrase “buy the summary function” to the smart speaker 60, payment confirmation information is transmitted from the payment management server 10 to the terminal 20 of the user, and a payment confirmation notification is displayed on the terminal 20 in response to receiving the payment confirmation information. In this example, as one example of the payment confirmation notification associated with the payment application, the standby screen of terminal 20 displays the message “A Payment App payment has been requested by the smart speaker.” along with a launch button (execution button) showing the text “open” for launching (executing) the payment application.

Note that the words that the user utters to the smart speaker 60 in order to purchase a paid function in the skill are not limited to the above example. As a non-limiting example, any words that express an intention to purchase or an intention to use a function registered in advance as a paid function in the skill, such as “make the summary function available” or “add the summary function” may be used.

When the launch button is tapped by the user, the payment application is launched, and the screen shown in FIG. 4-7 is displayed, for example. This screen is a purchase/payment confirmation screen shown in the payment application for example, and in this example shows the message “Purchase confirmation: purchase summary function for ¥300?”, a detail confirmation icon showing “>>See details” for checking the details, an icon showing “Yes” that is operated by the user in the case of consent to the content purchase, and an icon showing “No” that is operated by the user in the case of not consenting to the content purchase.

If the user taps the icon showing “Yes”, the payment management server 10 transmits settlement completion information to the terminal 20. Then, based on the received settlement completion information, settlement information (payment information) is displayed on the terminal 20 as shown in FIG. 4-8, for example. In the display example shown in FIG. 4-8, the settlement information includes the message “Payment: payment of ¥300 is complete.” and a detail confirmation icon showing “>>See details” for checking the details.

Further, for example, without limitation, the settlement completion information is also transmitted from the payment management server 10 to the skill provision server 50. Then, for example, without limitation, based on the settlement completion information being received by the skill provision server 50, information indicating that a paid function (billed function) in the skill has been enabled, or in other words that the paid function can be used (paid function enabled information, billed function enabled information) is transmitted from the skill provision server 50 to the smart speaker management server 40.

Then, in-skill function enabled information is transmitted from the smart speaker management server 40 to the smart speaker 60, and speech indicating that the in-skill function was enabled is output from the smart speaker 60 based on the fact that the in-skill function enabled information was received by the smart speaker 60. In this example, as shown in FIG. 4-9 for example, based on the fact that the “summary function” of the “Audiobook” skill was enabled, the phrase “The summary function is now available” is output from the smart speaker 60 as speech indicating that fact, for example, without limitation.

Processing

FIGS. 5-1 to 5-4 are flowcharts showing a flow of processing executed by devices according to some example embodiments.

These figures show examples of, in order from the left side, terminal main processing executed by the controller 21 of the terminal 20, smart speaker management server main processing executed by the controller 41 of the smart speaker management server 40, skill provision server main processing executed by the controller 51 of the skill provision server 50, payment management server main processing executed by the controller 11 of the payment management server 10, and smart speaker main processing executed by the controller 61 of the smart speaker 60. For example, without limitation, each processing described below is realized by the processor of a corresponding device reading a program from the memory and executing the program.

Note that the flowcharts described below are merely examples of processing procedures for realizing a method of the present disclosure. Therefore, processing for realizing a method of the present disclosure is not limited to processing executed in accordance with the flowcharts described below, and some operations (or steps) may be omitted, or other operations (or steps) may be added.

FIGS. 5-1 to 5-4 show the flow of processing in the case where payment is not needed at the start of using the skill but payment is individually needed for content, functions, or the like provided in the skill while using the skill, and other cases (skill paid sale/subscription) will be described later. Also, in the figures, the provider ID is shown as “provID”.

First, based on an operation performed on the input/output device 23, the smart speaker application processing function 212 of the terminal 20 transmits skill list data request information for requesting data indicating a list of skills that can be used by the smart speaker 60, to the smart speaker management server 40 via the communication I/F 22 (A111).

When the controller 41 of the smart speaker management server 40 receives the skill list data request information from the terminal 20 by the communication I/F 44 (B111), the controller 41 transmits skill list data to the terminal 20 via the communication I/F 44 based on the skill registration data 453 and the smart speaker registration data 452 stored in the storage device 45 (B113). Non-limiting examples of the skill list data include a skill ID, a provider ID, a skill use registration billing amount, and in-skill billing information.

When the smart speaker application processing function 212 of the terminal 20 receives the skill list data from the smart speaker management server 40 via the communication I/F 22 (A113), the smart speaker application processing function 212 displays the content of the skill list data on the display 24.

Next, based on an operation performed on the input/output device 23, the smart speaker application processing function 212 of the terminal 20 transmits skill addition request information, which includes a skill ID and an activation code, to the smart speaker management server 40 via the communication I/F 22 (A115).

Here, for example, without limitation, the activation code is an identification code generated in the controller 21 of the terminal 20 in order to specify skill addition request information, and, for example, without limitation, a random number having a desired (or alternatively, predetermined) number of digits can be generated in accordance with an algorithm for generating a random number, and the generated random number can be used as the activation code. In the figure, the activation code is shown as “activ.code”.

The controller 41 of the smart speaker management server 40 receives the skill addition request information from the terminal 20 via the communication I/F 44 (B115). Then, speaker addition request information, which includes the sID of the terminal 20 and the skill ID and the activation code that have been received from the terminal 20, and which requests the addition of the speaker that is to receive service, is transmitted to the skill provision server 50 via the communication I/F 44 (B117).

The controller 51 of the skill provision server 50 receives the speaker addition request information from the smart speaker management server 40 via the communication I/F 54 (C111). Then, the controller 51 of the skill provision server 50 adds the sID to the skill provision target registration data in the skill provision basic information data 552. The controller 51 of the skill provision server 50 also stores the combination of the sID and the activation code received in C111 in the storage device 55.

Subsequently, the controller 51 of the skill provision server 50 transmits skill addition approval information, which includes a skill ID and an sID, to the smart speaker management server 40 via the communication I/F 54 (C113).

The controller 41 of the smart speaker management server 40 receives the skill addition approval information from the skill provision server 50 via the communication I/F 44 (B119). Then, the controller 41 of the smart speaker management server 40 adds the skill ID that was received in B119 to the registered skill ID of the smart speaker registration data 452.

Further, the controller 41 of the smart speaker management server 40 references the smart speaker registration data 452, and transmits skill addition approval information indicating the completion of skill addition to the terminal 20 and the smart speaker 60 via the communication I/F 44 (B121).

Upon receiving the skill addition approval information via the communication I/F 22 (A116), the smart speaker application processing function 212 of the terminal 20 displays, on the display 24, a notification that the skill having the skill ID transmitted in A115 can be used.

Further, when the controller 61 of the smart speaker 60 receives the skill addition approval information via the communication I/F 62 (E111), the controller 61 outputs, from the speaker 66, a notification that the skill having the skill ID transmitted in A115 can be used.

Note that if the smart speaker 60 includes a display, the skill addition approval information may be displayed on the display. In some example embodiments, it is possible to implement a configuration in which neither the processing of E111 nor the processing of outputting, from the speaker 66, a notification that the skill having the skill ID transmitted in A115 can be used is performed.

Next, the terminal 20, the skill provision server 50, and the payment management server 10 execute payment consent confirmation processing.

Note that this payment consent confirmation processing may be executed at any timing as a subroutine program after B121 is executed.

Based on an operation performed on the input/output device 23, the smart speaker application processing function 212 of the terminal 20 transmits, to the payment application processing function 211, information for confirming whether or not the user consented to in-skill payment for the skill having the skill ID (skill payment confirmation information). For example, without limitation, the skill payment confirmation information includes the provider ID that corresponds to the skill ID and the activation code that was generated in A115.

Next, the payment application processing function 211 of the terminal 20 transmits the skill payment confirmation information to the payment management server 10 via the communication I/F 22 (A117).

The controller 11 of the payment management server 10 receives the skill payment confirmation information via the communication I/F 14 (D111). Next, the controller 11 of the payment management server 10 transmits, to the terminal 20 via the communication I/F 14, information indicating whether or not the user has consented to payment for a payment requested by the skill provider identified by the provider ID, or for a payment requested in a certain skill identified by the provider ID (payment consent confirmation information) (D113).

When the payment application processing function 211 of the terminal 20 receives the payment consent confirmation information from the payment management server 10 via the communication I/F 22 (A119), the received payment consent confirmation information is displayed on the display 24. Then, if the input/output device 23 detects an operation for consenting to the payment performed by the user of the terminal 20, the payment application processing function 211 transmits payment consent information to the payment management server 10 via the communication I/F 22 (A121).

The controller 11 of the payment management server 10 receives the payment consent information from the terminal 20 via the communication I/F 14 (D115). Next, the controller 11 transmits payment consented information that includes an mID and an activation code to the skill provision server 50 (C115). In this case, for example, without limitation, the controller 11 can transmit the payment consented information to the skill provision server 50 via an application programming interface (API) (e.g., a settlement API or a payment API), which is distributed (provided) by the payment management server 10 and is associated with the payment application (payment service).

When the controller 51 of the skill provision server 50 receives the payment consented information from the payment management server 10 via the communication I/F 54 (C115), the controller 51 executes ID information collation/verification processing (C117). For example, for example, without limitation, the sID paired with the received activation code is searched for in the storage device 55. Next, the sID obtained as the search result and the mID obtained from the payment consented information are stored in association with each other in the skill provision target registration data of the skill provision basic information data 552.

According to these operations, for example, without limitation, the skill provision server 50 can store one account (e.g., a payment application ID (mID)) and a second account (e.g., a smart speaker application ID (sID)) in association with each other.

Note that the smart speaker application may be configured to perform linking with a user account when initial setup of the smart speaker 60 is performed. In some example embodiments, a user account and the smart speaker 60 may be associated with each other at the factory before the smart speaker 60 is shipped from the factory.

In this way, by executing ID information collation/verification processing (a non-limiting example of third processing for associating a service with an account) based on the fact that payment consented information was received from the payment management server 10, the skill provision server 50 can appropriately associate a service provided by the voice control device with an account.

Note that if the smart speaker application and the smart speaker 60 have a one-to-one relationship for example, the sID is substantially the same as the ID (devID) of the smart speaker 60. In this case, the above ID association is synonymous with association between the account and the voice control device.

Further, steps A117 to A119 may be omitted in the payment consent confirmation processing.

In this case, in step A121, the payment application processing function 211 of the terminal 20 transmits payment consent information that includes a provider ID and an activation code to the payment management server 10.

After step C117 is complete, the skill provision server 50 may transmit information indicating that the ID information collation/verification processing is complete to the payment management server 10. Also, the payment management server 10 may transmit the received information to the terminal 20, and a notification that the ID information collation/verification processing is complete may be displayed on the terminal 20.

Based on a user utterance made to the smart speaker 60, the controller 61 of the smart speaker 60 transmits information indicating the launching of the skill that was added in the processing of FIG. 5-1 to the smart speaker management server 40 via the communication I/F 62. The controller 61 of the smart speaker 60 generates voice data indicating the user utterance made to the smart speaker 60, and transmits the generated voice data (information requesting paid intent purchase in skill (in-skill purchase request information)) to the smart speaker management server 40 via the communication I/F 62 (E113).

The controller 41 of the smart speaker management server 40 receives the voice data (in-skill purchase request information) from the smart speaker 60 via the communication I/F 44 (B123). Next, the controller 41 analyzes the user utterance content (analyzes the voice data) and calculates an iID for which purchase has been requested. The controller 41 then searches for the sID based on the devID of the smart speaker 60.

Next, the controller 41 of the smart speaker management server 40 transmits purchase request information that includes the analysis result of the voice data, the sID, and the iID to the skill provision server 50 via the communication I/F 44 (B125).

Upon receiving the purchase request information from the smart speaker management server 40 via the communication I/F 54 (C119), the controller 51 of the skill provision server 50 references the skill provision target registration data in the skill provision basic information data 552, and determines whether or not data is registered as the mID paired with the sID (whether or not the mID is a null value) (C121).

According to this operation, for example, without limitation, the skill provision server 50 can specify an account (e.g., a payment application ID (mID)) that is associated with a second account (e.g., a smart speaker application ID (sID)).

If data is not registered as the mID paired with the sID (the mID is a null value) (C121: NO), the controller 51 of the skill provision server 50 transmits information that prompts consent to a payment and includes the sID and the provider ID (payment consent request information) to the smart speaker management server 40 via the communication I/F 54 (C123).

Upon receiving the payment consent request information via the communication I/F 44 (B127), the controller 41 of the smart speaker management server 40 transmits information requesting the approval of payment from the skill provider identified by the provider ID (skill payment consent request information) to the terminal 20 via the communication I/F 44 (B129).

After A121, the terminal 20 receives the skill payment consent request information from the smart speaker management server 40 via the communication I/F 22 (A125). Next, the smart speaker application processing function 212 of the terminal 20 causes the display 24 to display information prompting the user to confirm payment consent (payment consent confirmation processing). Next, if payment is consented to on the display, payment consent confirmation processing is executed.

In the case of a skill for which payment consent is to be confirmed (hereinafter referred to as “target skill”), if data has not been registered in the mID (if the mID is a null value) paired with the sID in the skill provision target registration data in the skill provision basic information data 552 in FIG. 3-13, the determination result in C121 is “NO”. In this case, the skill provision server 50 transmits information for prompting the user to consent to payment in the target skill (skill payment consent request information) to the terminal 20 that has the sID stored in association with the null value in the skill provision target registration data via the smart speaker management server 40. Next, the skill payment consent request information is received by the terminal 20 (C123→B127→B129→A125).

The screen shown in FIG. 4-4, for example, is displayed on the display 24 of the terminal 20. Also, the payment consent confirmation processing shown in FIG. 5-2 is performed between the terminal 20 and various servers (A125→A117 to A121, D111 to D117, C115 to C117). Next, if the user consents to payment in the target skill, the mID of the terminal 20 is stored in the aforementioned null value field in the skill provision target registration data in the skill provision server 50 (D117→C115 to C117), and thus the sID and the mID are associated. Accordingly, in the skill provision basic information data 552, the skill (skill ID) (a non-limiting example of a service provided by a voice control device) and the mID (a non-limiting example of a settlement service account) are associated with each other.

In this way, the skill provision server 50 performs processing for transmitting payment consent request information to the terminal 20 via the smart speaker management server 40 (a non-limiting example of processing for associating a service provided by a voice control device with an account (e.g., a settlement service account)). Thus, in the skill provision server 50, the service provided by the voice control device is associated with the account, for example.

If data is registered for the mID paired with the sID (if mID is not a null value) (C121: YES), the controller 51 of the skill provision server 50 transmits billing request information that includes the provider ID, the mID, and a billing amount calculated based on the iID to the payment management server 10 via the communication I/F 54 (C125). In this case, the controller 51 can transmit the billing request information to the payment management server 10 via the API described above, for example, without limitation.

Here, if information requesting paid intent purchase in the skill (in-skill purchase request information) is transmitted from the smart speaker 60 to the smart speaker management server 40, the processing of C125 is executed as a result. This indicates that if the result of analyzing the user utterance content is that paid intent purchase in the skill was requested by voice, a billing request (settlement request) is transmitted from the skill provision server 50 to the payment management server 10.

According to this configuration, when the user who uses the voice control device gives a voice utterance requesting (desiring) to receive a paid service to the voice control device, a settlement request can be transmitted from an external server.

The controller 11 of the payment management server 10 receives the billing request information (a non-limiting example of a settlement request) from the skill provision server 50 via the communication I/F 14 (D119). This means that the payment management server 10 receives a settlement request for the usage fee of the service provided by the smart speaker 60 from the external server (skill provision server 50). Next, the controller 11 transmits payment confirmation information that includes the provider ID and the payment amount to the terminal 20 identified by the mID, via the communication I/F 14 (D121).

In this way, the payment management server 10 receives the billing request information regarding the billing amount (usage fee) of the skill by the payment application (a non-limiting example of a settlement service). Then, by transmitting payment confirmation information for settling the usage fee by the payment application through an operation performed on the terminal 20 corresponding to the specified mID, the payment management server 10 can easily settle the usage fee of the service provided by the voice control device by a settlement service through an operation performed on the terminal 20 corresponding to the specified account.

Upon receiving payment confirmation information from the payment management server 10 via the communication I/F 22 (A127), the payment application processing function 211 of the terminal 20 causes the display 24 to display a confirmation screen that includes information regarding the provider ID of the payment destination and the payment amount.

Upon receiving an operation for allowing payment from the user of the terminal 20 via the input/output device 23, the payment application processing function 211 of the terminal 20 transmits payment permission information to the payment management server 10 via the communication I/F 22 (A129).

Upon receiving the payment permission information from the terminal 20 via the communication I/F 14 (D123), the controller 11 of the payment management server 10 executes settlement processing with respect to the mID (D125). When settlement is complete, the controller 11 of the payment management server 10 transmits settlement completion information that includes the mID to the terminal 20 and the skill provision server 50 via the communication I/F 14 (D127).

Upon receiving the settlement completion information from the payment management server 10 via the communication I/F 22 (A131), the payment application processing function 211 of the terminal 20 causes the display 24 to display information indicating that the payment is complete.

Upon receiving the settlement completion information from the payment management server 10 via the communication I/F 54 (C127), the controller 51 of the skill provision server 50 adds an iID as a purchased intent related to the mID to the skill provision target registration data of the skill provision basic information data 552. Next, the controller 51 transmits billed function enabled information that includes the sID and the iID to the smart speaker management server 40 via the communication I/F 54 (C129).

Upon receiving the billed function enabled information from the skill provision server 50 via the communication I/F 44 (B131), the controller 41 of the smart speaker management server 40 transmits in-skill function enabled information that includes information indicating that the intent identified by iID in the skill can be used to the smart speaker 60 identified by the devID that was received in the step E113 via the communication I/F 44 (B133).

Upon receiving the in-skill function enabled information from the smart speaker management server 40 via the communication I/F 62, the controller 61 of the smart speaker 60 outputs, from the speaker 66, a notification that the intent whose purchase was requested in E113 can be used (E115).

Note that if the smart speaker 60 includes a display, the in-skill function enabled information may be displayed on the display.

In this way, the skill provision server 50 receives settlement completion information (a non-limiting example of settlement information indicating that the usage fee has been settled by the settlement service) from the payment management server 10. Next, based on the reception of the settlement completion information, the skill provision server 50 executes processing for transmitting the billed function enabled information to the smart speaker management server 40 (a non-limiting example of first processing for enabling service usage). Also, the smart speaker management server 40 executes processing for transmitting in-skill function enabled information to the smart speaker 60 (a non-limiting example of first processing for enabling service usage). Accordingly, based on the fact that settlement information indicating that the usage fee has been settled by the settlement service was received from the server that provides the settlement service, the user can use the service provided by the voice control device.

Also, due to the above first processing being executed based on the settlement completion information transmitted from the payment management server 10 and the specified mID, it is possible to block or prevent the case where the first processing is mistakenly executed with respect to another account.

### Effects of the Example Embodiment

According to the above example embodiment, an mID (a non-limiting example of an account) and an sID (a non-limiting example of information regarding a voice control device, a non-limiting example of information regarding a service provided by a voice control device, a non-limiting example of a second account related to a service different from the aforementioned account) are stored in the storage device 58 of the skill provision server 50 in association with each other. Also, an analysis result of analyzing voice-generated voice data received by the smart speaker 60 is transmitted from the smart speaker management server 40 to the skill provision server 50.

Next, the mID associated with the sID is specified by the skill provision server 50 based on the information stored in the storage device 58. Next, the payment management server 10 receives billing request information (a non-limiting example of a settlement request) regarding a usage fee of a skill (a non-limiting example of a service) provided by the smart speaker 60 (a non-limiting example of a voice control device) from the skill provision server 50 (a non-limiting example of an external server).

Next, when the settlement request is received, the payment management server 10 transmits payment confirmation information (a non-limiting example of information for settling the usage fee through operations performs on the terminal that corresponds to the specified account) to the terminal 20 that corresponds to the specified mID.

According to this configuration, it is possible to easily settle the usage fee of the service provided by the voice control device through an operation performed on the terminal that corresponds to the specified account.

Further, according to the example embodiment, the settlement request includes information for requesting settlement of a usage fee for using an in-skill function (a non-limiting example of a function provided as a paid function in a service provided by a voice control device), and thus the usage fee for using a function provided as a paid function in a service provided by a voice control device can be easily settled through an operation performed on the terminal that corresponds to the specified account.

Variations

The following describes variations of the above example embodiment.

Variation 1

In the above example embodiment, the payment application ID (mID) and the smart speaker application ID (sID) are stored in association with each other in the skill provision server 50, but the present inventive concepts are not limited to this.

For example, for example, without limitation, the ID (devID) of the smart speaker 60, the mID, and a purchased intent may optionally be stored in association with each other in the skill provision target registration data stored in the skill provision server 50.

According to such operations, for example, without limitation, the skill provision server 50 can store an account (e.g., a payment application ID (mID)) in association with a voice control device (e.g., a smart speaker 60 ID (devID)).

Also, according to such operations, for example, without limitation, the skill provision server 50 can specify an account (e.g., a payment application ID (mID)) that is associated with a voice control device (e.g., a smart speaker 60 ID (devID)).

Variation 2

In the above example embodiment, an activation code is generated in the terminal 20, but this may not be necessary. For example, upon receiving skill addition request information in B115 of FIG. 5-1, the smart speaker management server 40 may generate an activation code and transmit the generated activation code to the terminal 20.

Variation 3

In the above example embodiment, it is assumed that payment is not needed at the start of skill use, but payment may be needed at the start of skill use.

In this case, for example, without limitation, payment consent confirmation processing is executed after executing A115 in FIG. 5-1. Then, in B125 of FIG. 5-3, purchase request information transmission processing is executed for the skill ID of the skill that is to be used instead of the iID in the skill. In C127 of FIG. 5-4, upon receiving settlement completion information, the skill provision server 50 executes C113 of FIG. 5-1 and the addition of the skill is approved, thereby realizing this configuration.

Variation 4

In the above example embodiment, an intent is made permanently available after being purchased, but the present inventive concepts are not limited to this. For example, a payment system may be adopted in which an intent can be used for a certain period of time after purchase.

In this case, for example, without limitation, a purchased intent and an expiration date for the same are stored in the skill provision target registration data of the skill provision basic information data 552, thus realizing this configuration.

Variation 5

In the above example embodiment, the user of the smart speaker 60 registers usage of a skill using the smart speaker application of the terminal 20. However, the user of the smart speaker 60 may register usage of a skill using the smart speaker 60.

In this case, for example, without limitation, the smart speaker 60 transmits skill addition request information to the smart speaker management server 40. Then, upon receiving the skill addition request information from the smart speaker 60, the smart speaker management server 40 generates an activation code and transmits the generated activation code to the terminal 20, thus realizing this configuration.

Variation 6

In the above example embodiment, the controller 61 of the smart speaker 60 transmits in-skill purchase request information to the smart speaker management server 40 based on a user utterance given to the smart speaker 60, but the present inventive concepts are not limited to this.

For example, for example, without limitation, the user of the smart speaker 60 may transmit in-skill purchase request information using the smart speaker application executed on the terminal 20.

Variation 7

In the above example embodiment, the addition of a skill using the smart speaker application of the terminal 20, and the payment of a skill usage fee using the payment application of the terminal 20 are separate from each other. However, there is no need for such separation, and for example, the addition of a skill and the payment of a usage fee may be performed using the smart speaker application of the terminal 20.

In this case, for example, without limitation, the sID and mID are stored in the smart speaker application data 286 of the terminal 20. Further, the processing performed by the payment management server 10 is executed by the smart speaker management server 40, thus realizing this configuration.

Variation 8

In the above example embodiment, electronic money is used for payment of a skill usage fee, but this is not necessarily needed. For example, without limitation, settlement may be performed using a credit card or a bank account.

Variation 9

In the above example embodiment, in B129 of FIG. 5-3, the smart speaker management server 40 transmits skill payment consent request information to the terminal 20, but the present inventive concepts are not limited to this.

In one specific example, the skill provision server 50 transmits skill payment consent request information to the smart speaker 60 via the smart speaker management server 40. The smart speaker 60 may then make a voice-based request to the user using the speaker 66.

In this way, for example, the skill provision server 50 executes processing for, via the smart speaker management server 40, causing the smart speaker 60 to output, by audio, information for prompting payment consent confirmation (a non-limiting example of information related to an association between a service provided by a voice control device and an account), thus making it possible to obtain payment consent with the easy-to-understand method using voice output from the voice control device. Due to consent to payment, it is possible to associate the service provided by the voice control device with the account.

Variation 10

In the above example embodiment, the payment application is used to confirm with the user whether or not the user consents to in-skill payment, but the present inventive concepts are not limited to this. For example, for example, without limitation, a “friend” function in a messaging service such as the previously described IMS may be used to ask the user to confirm whether or not to make an in-skill payment by using the payment application.

FIGS. 4-10 and 4-11 show examples of screens displayed on the display 24 of the terminal 20 in this variation. These figures show screens that correspond to FIGS. 4-3 and 4-4 described in the above example embodiment, respectively.

In FIG. 4-10, a friend addition confirmation icon FC2 for adding a business operator account (hereinafter called an “official account”) created by a skill provider for a provided skill (here, “Audiobook”) as a friend in a messaging application is displayed below information regarding the creator of the “Audiobook” skill. When the friend addition confirmation icon FC2 is tapped by the user, for example, without limitation, the messaging application is launched (executed) on the terminal 20, and the screen shown in FIG. 4-11 is displayed, for example.

Here, for example, without limitation, “friend” means associating (linking) accounts with each other in a messaging application. For example, without limitation, by adding friends in a messaging application, it is possible to transmit and receive content such as messages, and to receive information distribution services for distribution of information from official accounts registered as friends. In this variation, adding a friend can be said to be an operation performed by the user of the terminal 20 to show an intention to consent to in-skill payment.

The screen in FIG. 4-11 is a friend addition screen for a messaging application (Messaging App), and for example, without limitation, as information for adding the official account for “Audiobook” as a friend, an add friend button labeled as “add” and a talk button labeled as “talk” for chatting with the official account are displayed in association with the “Audiobook” skill that has been selected by the user.

When the button labeled as “add” is tapped by the user, the official account for the corresponding skill is added as a friend, and consent is given to in-skill payment for that skill. Accordingly, payments within the “Audiobook” skill can be made using a payment application.

In some example embodiments, the official account may be automatically added as a friend when a button labeled “start using” is tapped by the user.

In this example, the total number of users who have registered the “Audiobook” skill as a friend may be displayed in the area under the skill name “Audiobook”. For example, without limitation, this calculation can be performed by the server (hereinafter, referred to as the “messaging service server”) of the business operator that provides the messaging service (messaging application).

Note that this calculation and the display of the total number of users are not essential and can be omitted.

After “start using” has been tapped for the “Audiobook” skill, similarly to FIG. 4-5 for example, if the user says “buy the summary function” to the smart speaker 60, information is transmitted from the smart speaker 60 to the smart speaker management server 40 and then to the skill provision server 50 similarly to the above example embodiment. Next, for example, without limitation, settlement information for performing settlement using a payment application (payment service) is transmitted to the terminal 20 by the skill provision server 50 via an API distributed by the messaging service server (e.g., a messaging API) (skill provision server 50→messaging service server→terminal 20). Next, based on the reception of the settlement information, for example, a notification similar to the payment confirmation notification shown in FIG. 4-6 is displayed on the terminal 20. Then, based on the displayed notification, the terminal 20 executes processing for settlement using the payment application (payment service).

In this variation, the above-described friend registration is performed for each skill, and in the case of a skill for which friend registration has been performed, it is determined that the user has consented to settlement using the payment application. Similarly, to the above example embodiment, when a paid function of the skill is to be used, settlement is performed using the payment application.

Further, if the official account has not been added as a friend, the skill provision server 50 can prompt the user of the terminal 20 to add the official account as a friend by the following methods, which are non-limiting examples.

(1) Through voice guidance provided by the smart speaker 60, give a notification to go to the smart speaker application and then to the skill store, search for the target skill in the skill list, and then perform friend addition.

(2) Give a push notification to the smart speaker application, and when the user taps the push notification displayed on the terminal 20, the above-mentioned friend addition screen opens.

As another non-limiting example, in the case where the distribution of information from the official account is refused on the terminal 20 (if the official account is blocked), the skill provision server 50 can, through voice guidance provided by the smart speaker 60, notify the user to unblock the official account.

Note that the payment application may be any application associated with the messaging application. For example, the payment application may be configured as a function in the messaging application, or the messaging application and the payment application may be configured as different applications that share user information.

Further, when applying this variation, the account in the above example embodiment can be an account of the messaging application (e.g., an MS ID) instead of the account of the payment application.

In this case, for example, the smart speaker application ID (sID) or the smart speaker ID (devID), the messaging application ID (MS ID), and the purchased intent can be stored in association with each other in the skill provision target registration data stored in the skill provision server 50.

Further, the payment management server 10 may have a function for providing a messaging service (MS) such as an IMS and a function for providing a payment service through a payment application.

Further, the server having a function for providing the messaging service and the server having a function for providing various services through a payment application may be separate servers, or in other words, there may be two servers, namely a messaging service server and a payment service server.

For example, if the payment application is a multi-function application that has a messaging service (MS) function, the skill provider registration database 153 can be said to be a database for managing skill provider groups.

Here, “skill provider group” refers to a group of skill providers in a messaging application for a business operator.

### OTHER REMARKS

The various functional modules, units, or means included in the system of the present disclosure can be provided in the various devices described in the above example embodiments, and are not limited to the configurations of the above example embodiments.

For example, in the above example embodiments, the skill provision server 50 is provided with a storage device (e.g., memory) and various modules, but some or all of these may be provided in the smart speaker management server 40, the payment management server 10, or the messaging service server, for example.

Further, in the above example embodiments, the payment management server 10 is provided with a reception means (e.g., a reception module) for receiving a settlement request from the skill provision server 50, but the reception means may be provided in the messaging service server, for example.

Further, in the above example embodiments, the payment management server 10 is provided with a second transmission means (e.g., a second transmission module) for transmitting information for settling the usage fee through operations performed on the terminal that corresponds to the specified account, but the second transmission means may be provided in the messaging service server, for example.

Further, the external server in the system of the present disclosure may be the smart speaker management server 40, for example, and the payment management server 10 or the messaging service server may receive a settlement request from the smart speaker management server 40.

In this case, for example, without limitation, in accordance with an instruction from the skill provision server 50, settlement information can be transmitted by the smart speaker management server 40 to the terminal 20 via a settlement API associated with the payment application distributed by the payment management server 10 (smart speaker management server 40→payment management server 10 (or messaging service server)→terminal 20).

Any functional blocks or modules (or a combination of two or more of the functional blocks or modules) shown in the figures and/or described above may be implemented in processing circuitry such as hardware including logic circuits, a hardware/software combination such as a processor executing software, or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

It should be understood that the example embodiments described herein should be considered in a descriptive sense only and not for purposes of limitation. While some example embodiments have been particularly shown and described, it will be understood by one of ordinary skill in the art that variations in form and detail may be made therein without departing from the spirit and scope of the claims.

What is claimed is:

1. A system comprising:
a memory configured to store an account and a voice control device in association with each other; and
at least one processor configured to,
analyze voice data generated based on an utterance accepted by the voice control device, and transmit an analysis result to an external server,
specify the account that is associated with the voice control device,
receive, from the external server, a settlement request for a usage fee of a service, which is provided by the voice control device, and
transmit information for settling the usage fee through an operation performed on a terminal that corresponds to the specified account upon receiving the settlement request.

2. The system according to claim 1, wherein the settlement request is transmitted from the external server in response to the service being a paid service and the analysis result indicating that the utterance requests usage of the service.

3. The system according to claim 1, wherein
the memory is further configured to store the account and a second account in association with each other, the second account being different from the account and relating to the service, and
the at least one processor is further configured to specify the account that is associated with the second account.

4. The system according to any one of claim 1, wherein the memory is further configured to store (i) an account of a settlement service for performing settlement using electronic money, or (ii) an account of a messaging service that is associated with the settlement service.

5. The system according to claim 4, wherein the at least one processor is further configured to,
receive the settlement request that requests settlement of the usage fee for using the settlement service, and
settle the usage fee for using the settlement service through an operation performed on the terminal that corresponds to the specified account.

6. The system according to claim 5, wherein the at least one processor is further configured to,
receive, from a settlement server configured to provide the settlement service, settlement information indicating that the usage fee for using the settlement service has been settled; and
enable usage of the service, based on reception of the settlement information.

7. The system according to claim 6, wherein the at least one processor is configured to enable the usage of the service based on the settlement information and the specified account.

8. The system according to any one of claim 4, wherein the at least one processor is further configured to associate the service with the account of the settlement service or the account of the messaging service.

9. The system according to claim 8, wherein the at least one processor is further configured to cause to display information regarding association of the service and the account.

10. The system according to claim 8, wherein the at least one processor is further configured to cause the voice control device to output, by audio, information regarding association of the service and the account.

11. The system according to any one of claim 8, wherein the at least one processor is further configured to associate the service with the account.

12. The system according to claim 1, wherein the settlement request includes a request for the usage fee for using a function provided as a paid function in the service.
